(19) United States
(12) Patent Application Publication
(10) Pub. No.: US 2025/0101306 A1
(43) Pub. Date: Mar. 27, 2025

(54) LIQUID CRYSTAL COMPOSITION AND DISPLAY PANEL

(71) Applicant: TCL CHINA STAR OPTOELECTRONICS TECHNOLOGY CO., LTD., ShenZhen (CN)

(72) Inventors: Xiao LIU, ShenZhen (CN); Ji LI, ShenZhen (CN)

(21) Appl. No.: 18/495,987

(22) Filed: Oct. 27, 2023

(30) Foreign Application Priority Data
Sep. 26, 2023 (CN) 202311247515.7

(51) Int. Cl. C09K 19/34

(52) U.S. Cl. CPC C09K 19/3491; C09K 19/3405

(57) ABSTRACT

Embodiments of the present disclosure discloses a liquid crystal composition and a display panel. The liquid crystal composition includes at least one first compound represented by formula (I). By adding the first compound to the liquid crystal composition, the performance of the liquid crystal composition is improved in terms of clearing point, elastic coefficient, and the like, thereby improving the display contrast and product quality of a display panel using the liquid crystal composition are improved.

### CROSS-REFERENCE TO RELATED APPLICATION

The present disclosure claims priority to and the benefit of Chinese Patent Application No. 202311247515.7, filed on Sep. 26, 2023, the disclosure of which is incorporated herein by reference in its entirety.

### TECHNICAL FIELD

The present disclosure relates to the field of display, and in particular, to a liquid crystal composition and a display panel.

### BACKGROUND

By applying voltage to a liquid crystal layer, a liquid crystal display panel can control the optical properties of materials in the liquid crystal layer, thus realizing the display function of the liquid crystal display panel. The physical properties (e.g., viscosity, clearing point, dielectric anisotropy, optical anisotropy, elastic coefficient, etc.) of the liquid crystal materials of the liquid crystal layer affect the display effect and the product quality of the liquid crystal display panel. At present, the performance of the materials applied to the liquid crystal layer still needs to be improved, which makes it difficult to improve the display effect and product quality of display panel.

Therefore, there is an urgent need for a liquid crystal composition and a display panel to solve the above-mentioned technical problems.

### SUMMARY

The present disclosure provides a liquid crystal composition and a display panel, which can alleviate the technical problems that the display effect and the product quality of the display panel are difficult to improve due to the fact that the material properties in the liquid crystal layer need to be improved.

The present disclosure provides a liquid crystal composition, which includes at least one first compound represented by a formula (I):

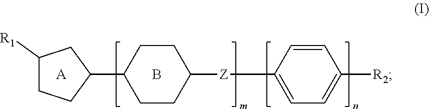

wherein, m and n are each independently selected from 0, 1, 2 and 3, and a sum of m and n is greater than or equal to 1;

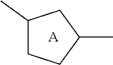

is independently selected from

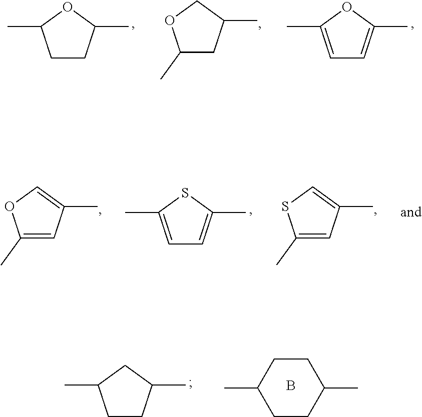

is independently selected from

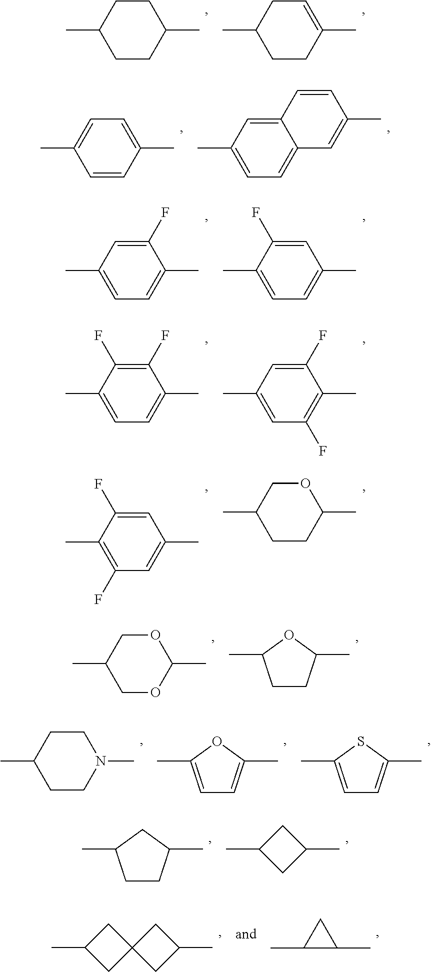

and at least one H in

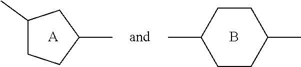

is substituted with any one of F, CI, Br, I and H;
Z is independently selected from a single bond, —O—, —C(O)O—, —OC(O)—, —CF₂O—, —OCF₂—, —CH₂CH₂—, —CF₂CF₂—, —CH₂O—, —OCH₂—, —CH═CH— or —C≡C—, and in a case that any Z is selected from a group with H, the H in any Z is unsubstituted or at least one H is substituted with any one of F, Cl, Br and I; and
R₁ and R₂ are each independently selected from H, F, Cl, Br, I, CN, SCN, NCS, SF₅, a substituted or an unsubstituted alkyl having 1 to 15 carbon atoms, a substituted or an unsubstituted alkoxy having 1 to 15 carbon atoms, a substituted or an unsubstituted alkenyl having 2 to 15 carbon atoms, a substituted or an unsubstituted alkenyloxy having 2 to 15 carbon atoms, a substituted or an unsubstituted alkynyl having 2 to 15 carbon atoms, and a substituted or an unsubstituted alkynyloxy having 2 to 15 carbon atoms.

Exemplarily, terminal groups of R₁ and R₂ are each independently monosubstituted with H, CN or CF₃; and/or
one or more —CH₂— in R₁ and R₂ are each independently substituted with —O—, —S—, —SO₂—, —CO—, —C(O)O—, —OC(O)—, —OC(O)O—, —CF₂O—, —OCF₂—, —CH₂—CH₂—, —(CH₂)₃—, —CF₂—CF₂—, —CF₂—CH₂—, —CH₂—CF₂—, —CHF—CHF—, —CH₂O—, —OCH₂—, —CF═CH—, —CH═CF—, —CF═CF—, —CH═CH— or —C≡C—, and are not directly bonded to heteroatoms that are directly bonded to C, and H in R₁ and R₂ is unsubstituted or at least one H is substituted with any one of F, Cl, Br and I.

Exemplarily, the first compound has a structure represented by at least one of formulas I-1 to I-37:

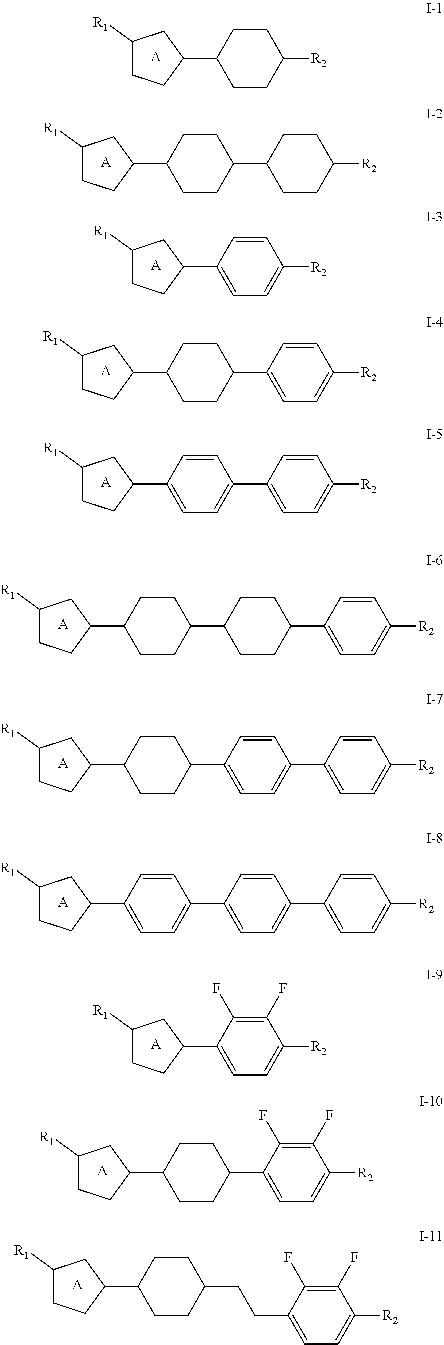

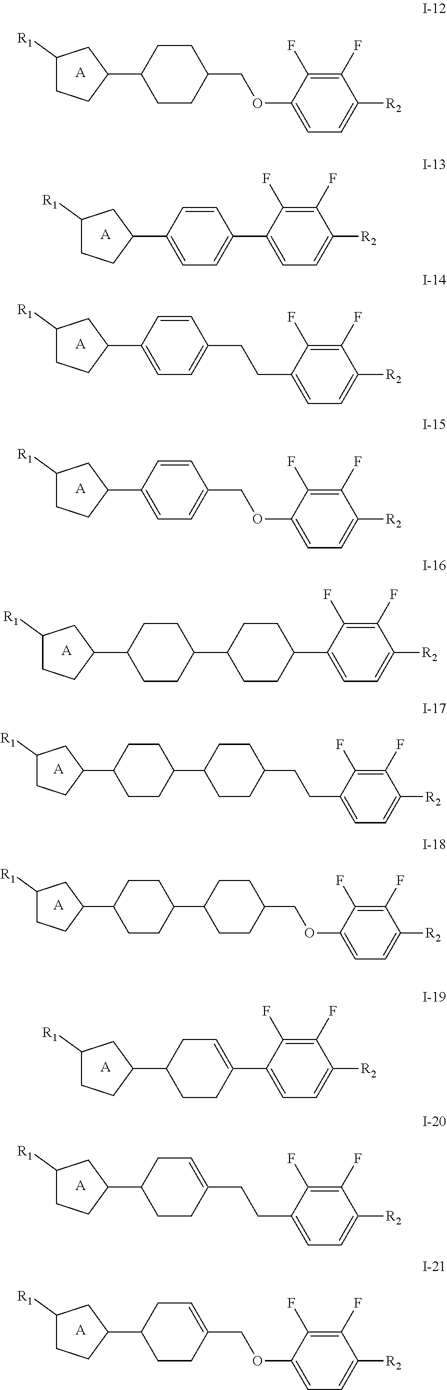

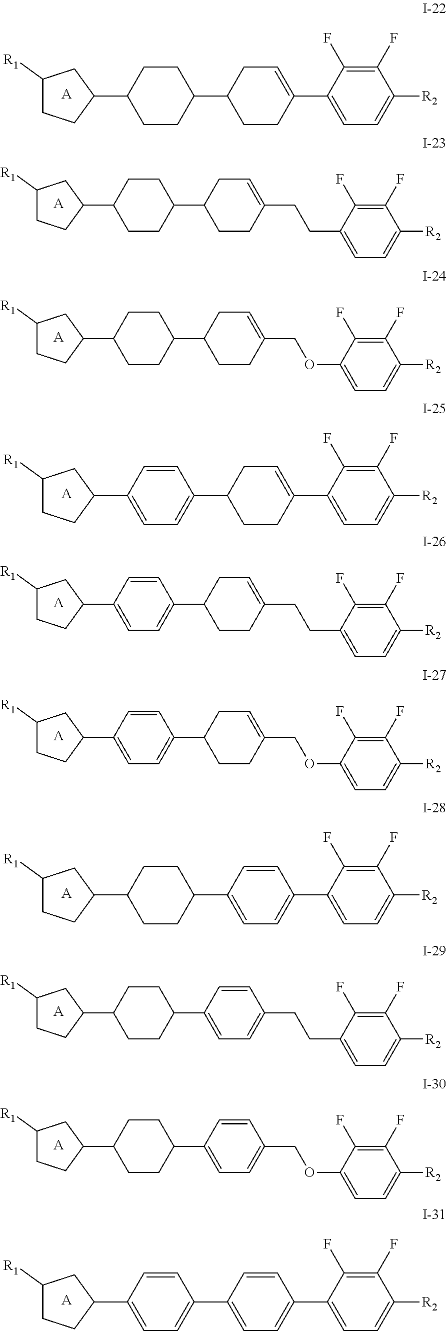

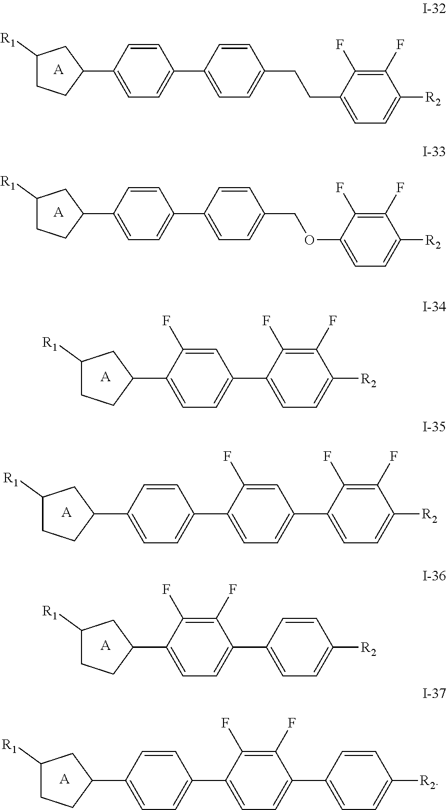

Exemplarily,

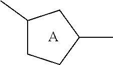

is independently selected from

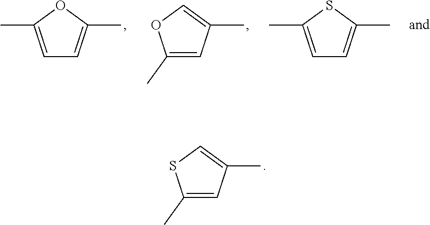

Exemplarily, the first compound has a structure represented by at least one of formulas IA-1 to IA-67:

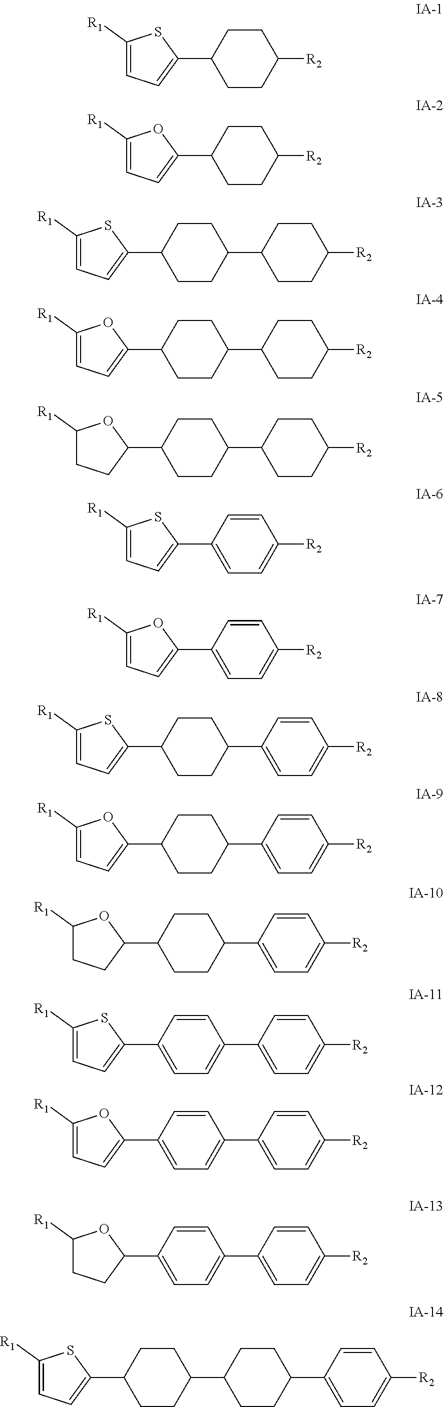

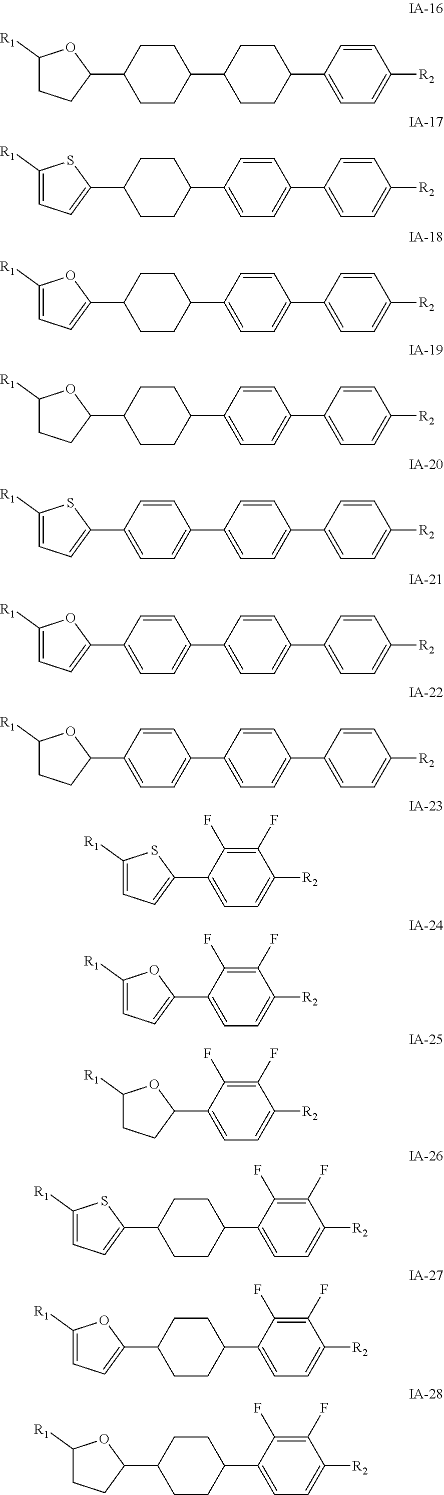

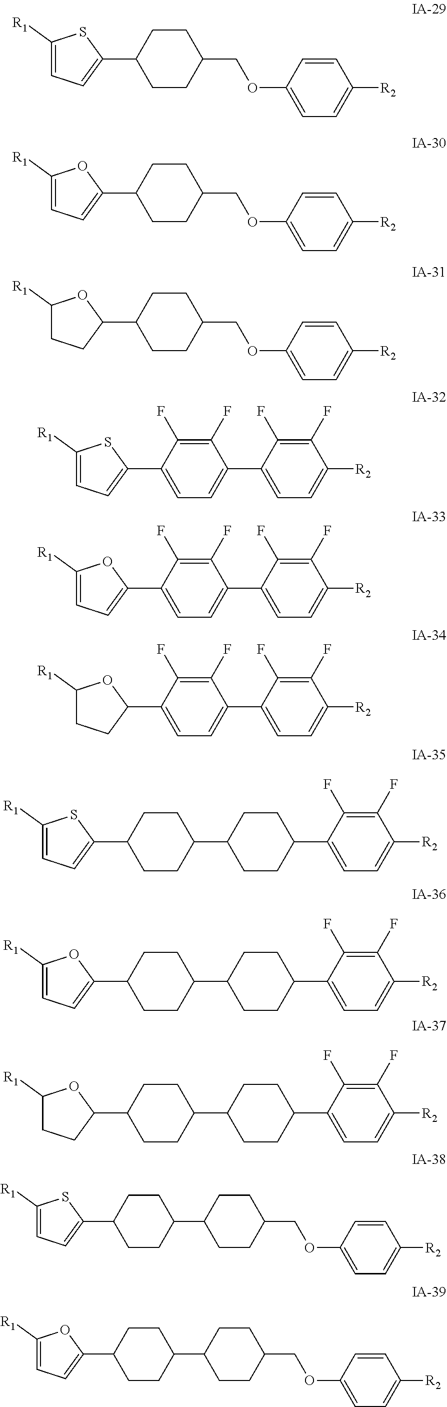

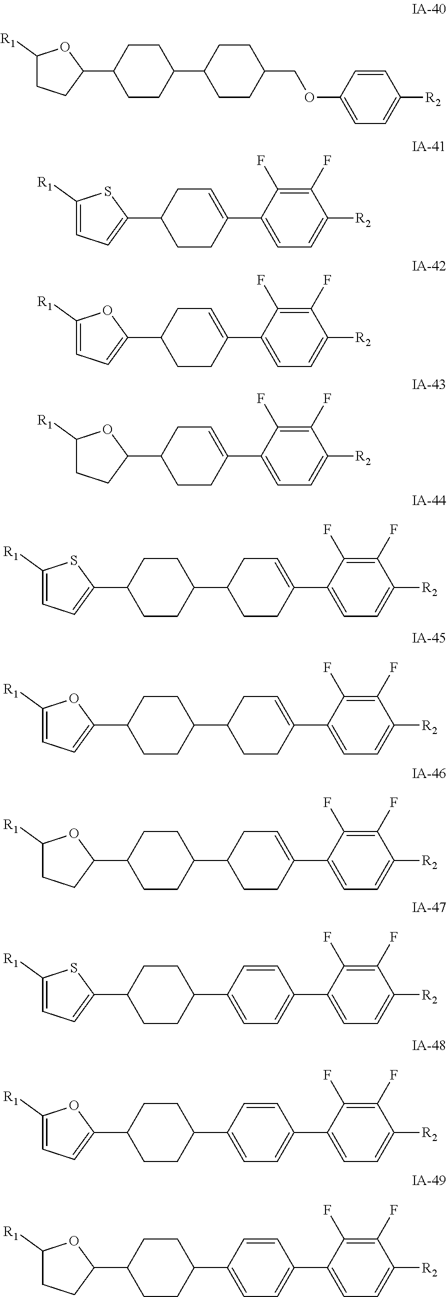

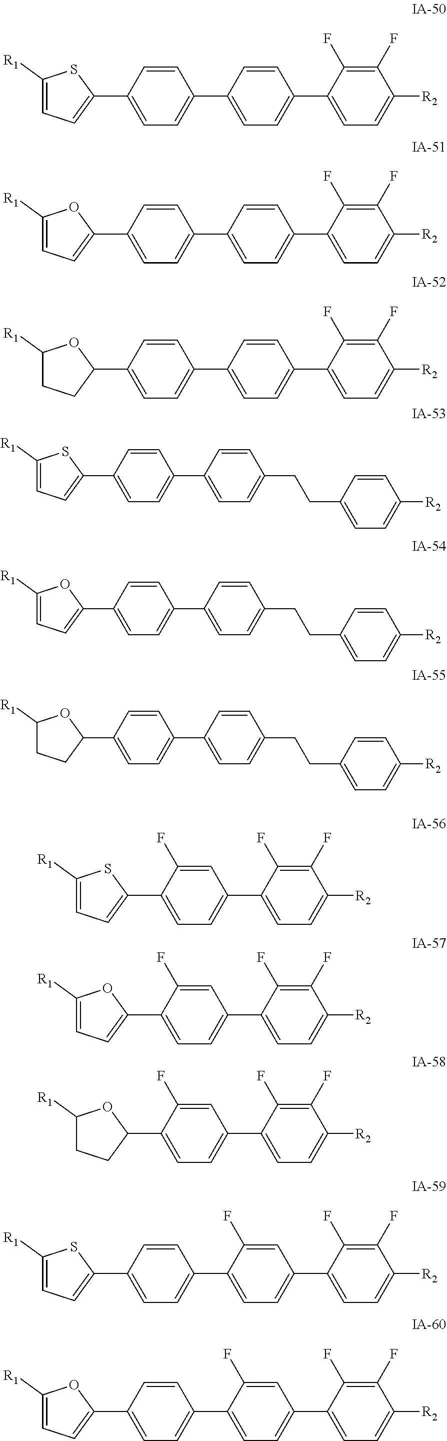

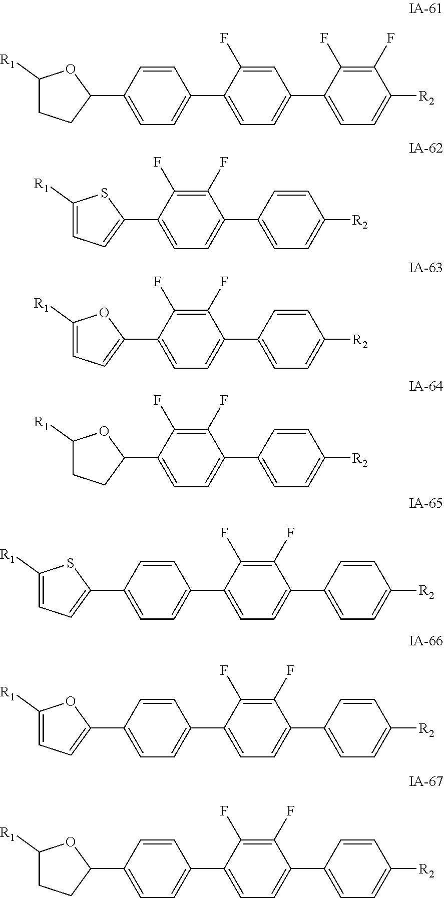

Exemplarily, R₁ and R₂ are each independently selected from H, F, an unsubstituted alkyl having 1 to 7 carbon atoms, an unsubstituted alkoxy having 1 to 7 carbon atoms, and an unsubstituted alkenyl having 2 to 7 carbon atoms.

Exemplarily, the liquid crystal composition further includes at least one second compound with a structure represented by at least one of formulas II-1 to II-9:

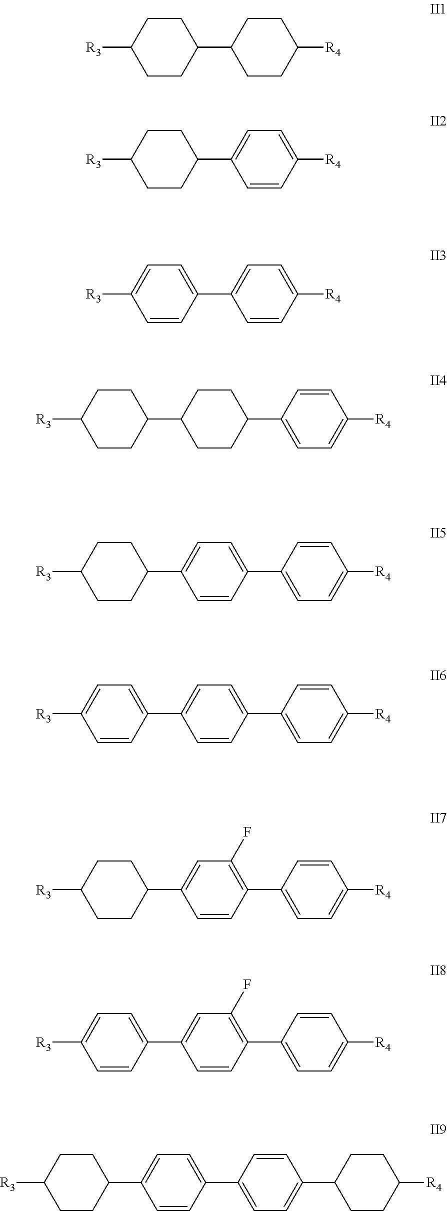

wherein R₃ and R₄ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or an unsubstituted alkenyloxy having 2 to 10 carbon atoms, a substituted or an unsubstituted alkynyl having 2 to 10 carbon atoms, and substituted or unsubstituted alkynyloxy having 2 to 10 carbon atoms, and H in R₃ and R₄ is unsubstituted or at least one H is substituted by any one of F, Cl, Br and I.

Exemplarily, the liquid crystal composition further includes at least one third compound with a structure represented by at least one of formulas III-1 to III-5:

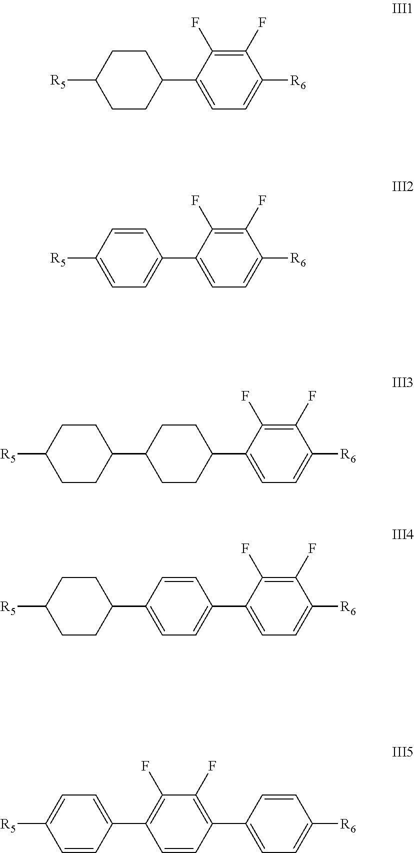

wherein R₅ and R₆ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or unsubstituted alkenyloxy having 2 to 10 carbon atoms, a substituted or unsubstituted alkynyl having 2 to 10 carbon atoms, and a substituted or unsubstituted alkynyloxy having 2 to 10 carbon atoms, and H in R₅ and R₆ is unsubstituted or at least one H is substituted with any one of F, Cl, Br, I, CH₃ and CN.

Exemplarily, in the liquid crystal composition, a mass fraction of the first compound is greater than or equal to 1%, and the mass fraction of the first compound is less than or equal to 70%;
in the liquid crystal composition, a mass fraction of the second compound is greater than or equal to 10%, and the mass fraction of the second compound is less than or equal to 70%; and in the liquid crystal composition, a mass fraction of the third compound is greater than or equal to 10%, and the mass fraction of the third compound is less than or equal to 70%.

The present disclosure further provides a display panel including a first substrate, a second substrate disposed on the first substrate, and a liquid crystal layer disposed between the first substrate and the second substrate
wherein the liquid crystal layer includes the liquid crystal composition as described above.

According to the present disclosure, by adding the first compound to the liquid crystal composition, the performance of the liquid crystal composition is improved in terms of clearing point, elastic coefficient, and the like, thereby improving the display contrast and product quality of a display panel using the liquid crystal composition are improved.

### BRIEF DESCRIPTION OF THE DRAWINGS

In order to more clearly illustrate the embodiments of the present disclosure or the technical solutions in the prior art, the drawings used in the embodiments will be briefly described below. Obviously, the drawings in the following description are only partial embodiments of the present disclosure, and those skilled in the art can obtain other drawings according to the drawings without any creative work.

FIG. 1 is a flow chart of a method for preparing a liquid crystal composition according to some embodiments of the present disclosure; and

FIG. 2 is a schematic structural diagram of a display panel according to some embodiments of the present disclosure.

### DETAILED DESCRIPTION

Hereinafter, technical solutions in embodiments of the present disclosure will be clearly and completely described with reference to the accompanying drawings in embodiments of the present disclosure. Apparently, the described embodiments comprise but are not limited to the embodiments of the present disclosure. Other embodiments that can be obtained by a person with ordinary skill in the art on the basis of the embodiments in the present disclosure without creative labor belong to the protection scope of the present disclosure. In addition, it should be understood that the specific embodiments described herein are intended only to illustrate and explain the present disclosure and are not intended to limit the present disclosure. In the present disclosure, in the absence of contrary description, directional words such as “up” and “down” generally refer to the up and down in the actual use or working state of a device, and specifically the drawing direction in the accompanying drawings. While “inside” and “outside” are for profile of the device.

Currently, since the performance of the materials of the liquid crystal layer needs to be improved, there is a problem that it is difficult to improve the display effect and product quality of the liquid crystal display panel.

An embodiment of the present disclosure provides a liquid crystal composition including at least one first compound represented by a formula (I):

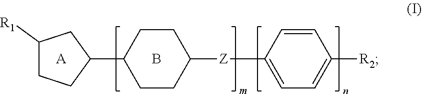

wherein, m and n are each independently selected from 0, 1, 2 and 3, and a sum of m and n is greater than or equal to 1;

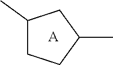

is independently selected from

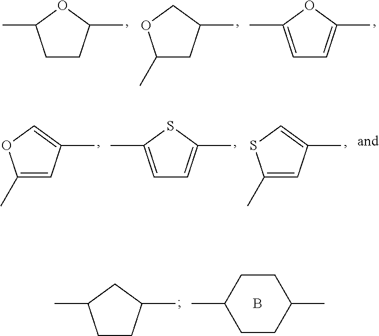

is independently selected from

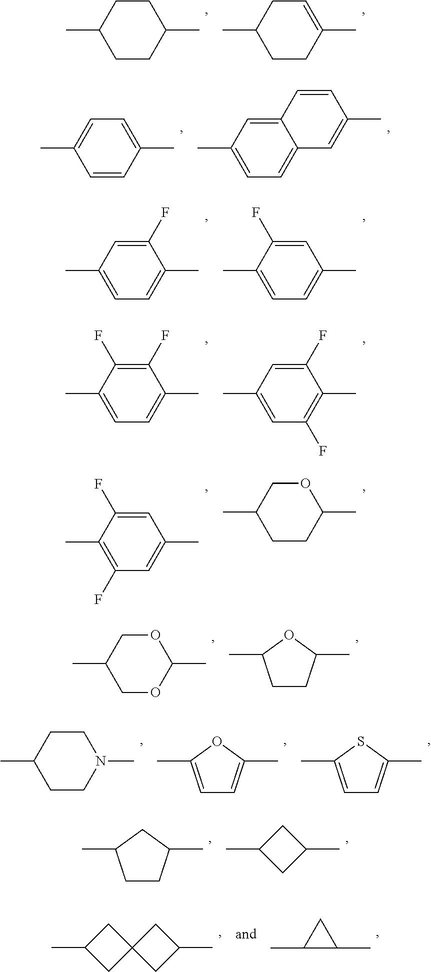

and at least one H in

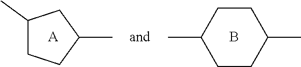

is substituted with any one of F, CI, Br, I and H;
Z is independently selected from a single bond, —O—, —C(O)O—, —OC(O)—, —CF₂O—, —OCF₂—, —CH₂CH₂—, —CF₂CF₂—, —CH₂O—, —OCH₂—, —CH═CH— or —C≡C—, and in a case that any Z is selected from a group with H, the H in any Z is unsubstituted or at least one H is substituted with any one of F, Cl, Br and I; and
R₁ and R₂ are each independently selected from H, F, Cl, Br, I, CN, SCN, NCS, SF₅, a substituted or an unsubstituted alkyl having 1 to 15 carbon atoms, a substituted or an unsubstituted alkoxy having 1 to 15 carbon atoms, a substituted or an unsubstituted alkenyl having 2 to 15 carbon atoms, a substituted or an unsubstituted alkenyloxy having 2 to 15 carbon atoms, a substituted or an unsubstituted alkynyl having 2 to 15 carbon atoms, and a substituted or an unsubstituted alkynyloxy having 2 to 15 carbon atoms.

The addition of the first compound is beneficial to improving the average value of the clearing point and the elastic coefficient of the liquid crystal composition, and can effectively improve the light leakage problem in dark state of the display panel in a case that the liquid crystal composition is applied to the display surface, thereby improving the display contrast and product quality of the display panel in a case that the liquid crystal composition is applied to the display surface.

According to embodiments of the present disclosure, by adding the first compound to the liquid crystal composition, the performance of the liquid crystal composition is improved in terms of clearing point, elastic coefficient, and the like, thereby improving the display contrast and product quality of a display panel using the liquid crystal composition are improved.

In this embodiment, in each optional group of

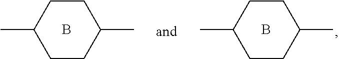

“-” represents a linking site.

In some embodiments, terminal groups of R₁ and R₂ are each independently monosubstituted with H, CN or CF₃.

In some embodiments, one or more —CH₂— in R₁ and R₂ are each independently substituted with —O—, —S—, —SO₂—, —CO—, —C(O)O—, —OC(O)—, —OC(O)O—, —CF₂O—, —OCF₂—, —CH₂—CH₂—, —(CH₂)₃—, —CF₂—CF₂—, —CF₂—CH₂—, —CH₂—CF₂—, —CHF—CHF—, —CH₂O—, —OCH₂—, —CF═CH—, —CH═CF—, —CF═CF—, —CH═CH— or —C≡C—, and are not directly bonded to heteroatoms that are directly bonded to C, and H in R₁ and R₂ is unsubstituted or at least one H is substituted with any one of F, Cl, Br and I. That is to say, H in R₁ is unsubstituted or at least one H is substituted with any one of F, CI, Br and I, and H in R₂ is unsubstituted or at least one H is substituted with any one of F, CI, Br and I.

In some embodiments, R₁ and R₂ are each independently selected from H, F, CI, Br, a substituted or an unsubstituted alkyl having 1 to 7 carbon atoms, a substituted or an unsubstituted alkoxy having 1 to 7 carbon atoms, a substituted or an unsubstituted alkenyl having 2 to 7 carbon atoms, a substituted or an unsubstituted alkenyloxy having 2 to 7 carbon atoms, a substituted or an unsubstituted alkynyl having 2 to 7 carbon atoms, and a substituted or an unsubstituted alkynyloxy having 2 to 7 carbon atoms.

Exemplarily, R₁ and R₂ are each independently selected from H, F, an unsubstituted alkyl having 1 to 7 carbon atoms, an unsubstituted alkoxy having 1 to 7 carbon atoms, an unsubstituted alkenyl having 2 to 7 carbon atoms, an unsubstituted alkenyloxy having 2 to 7 carbon atoms, an unsubstituted alkynyl having 2 to 7 carbon atoms, and an unsubstituted alkynyloxy having 2 to 7 carbon atoms.

Exemplarily, R₁ and R₂ are each independently selected from H, F, an unsubstituted alkyl having 1 to 5 carbon atoms, an unsubstituted alkoxy having 1 to 5 carbon atoms, and an unsubstituted alkenyl having 2 to 5 carbon atoms.

In some embodiments, in a case that R₁ and R₂ are each independently selected from an unsubstituted alkyl, an unsubstituted alkenyl, or an unsubstituted alkynyl, the unsubstituted alkyl, unsubstituted alkenyl, and unsubstituted alkynyl are aliphatic hydrocarbon groups.

In some embodiments, in a case that R₁ and R₂ are each independently selected from an unsubstituted alkyl, the unsubstituted alkyl may be an unsubstituted linear alkyl or an unsubstituted branched alkyl, optionally an unsubstituted linear alkyl; in a case that R₁ and R₂ are each independently selected from an unsubstituted linear alkyl having 1 to 7 carbon atoms, R₁ and R₂ may be selected from, for example, methyl, ethyl, propyl, butyl, pentyl, hexyl or heptyl.

In a case that R₁ and R₂ are each independently selected from an unsubstituted alkenyl, the unsubstituted alkenyl may be an unsubstituted linear alkenyl or an unsubstituted branched alkenyl, and the alkenyl may be an isomer in E configuration and Z configuration, and has at least one carbon-carbon double bond, and may be selected from an unsubstituted linear alkenyl, such as group having 2 to 7 carbon atoms, optionally ethenyl, prop-1-enyl, prop-2-enyl, but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-4-enyl, hept-5-enyl, hept-6-enyl, and the like.

In a case that R₁ and R₂ are each independently selected from an unsubstituted alkynyl, the unsubstituted alkynyl may be an unsubstituted linear alkynyl or an unsubstituted branched alkynyl, and has at least one carbon-carbon triple bond, and may be selected from an unsubstituted linear alkynyl, such as having from 2 to 7 carbon atoms, optionally ethynyl, prop-1-ynyl, prop-2-ynyl, but-1-ynyl, but-2-ynyl, but-3-ynyl, pent-1-ynyl, pent-2-ynyl, pent-3-ynyl, pent-4-ynyl, hex-1-ynyl, hex-2-ynyl, hex-3-ynyl, hex-4-ynyl, hex-5-ynyl, hept-1-ynyl, hept-2-ynyl, hept-3-ynyl, hept-4-ynyl, hept-5-ynyl or hept-6-ynyl, and the like; and further optionally prop-2-ynyl, but-2-ynyl, but-3-ynyl, pent-2-ynyl, pent-3-ynyl or pent-4-ynyl.

In some embodiments, the sum of m and n is greater than or equal to 1 and less than or equal to 3, which is beneficial to increasing the number of rigid rings in the first compound, thereby increasing the average value of the cooling point and the elastic coefficient of the liquid crystal composition, further effectively improving the light leakage problem in dark state of the display panel in a case that the liquid crystal composition is applied to the display surface, thereby improving the display contrast and product quality of the display panel in a case that the liquid crystal composition is applied to the display surface.

In some embodiments, the first compound has a structure represented by at least one of formulas I-1 to I-37:

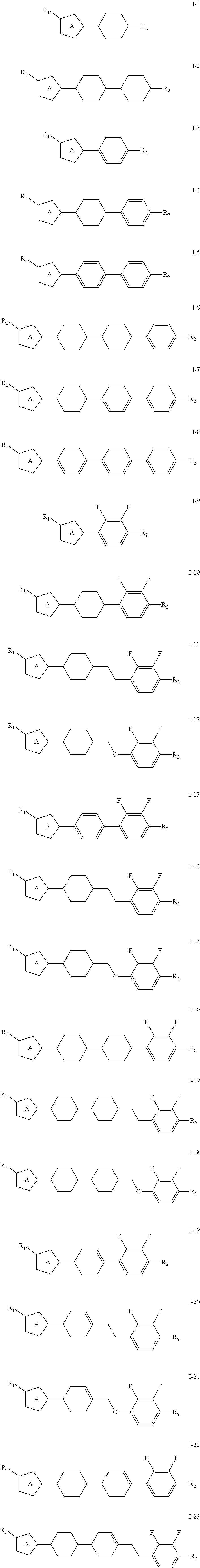

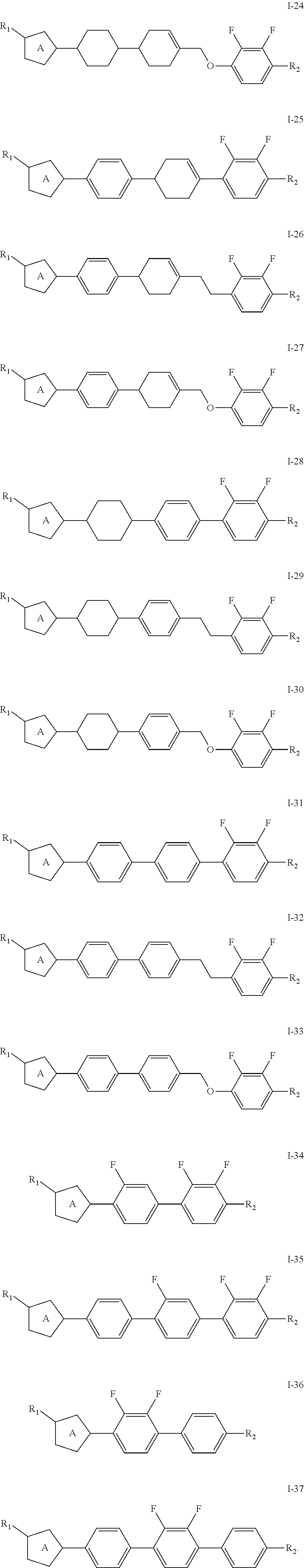

Exemplarily,

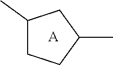

is independently selected from

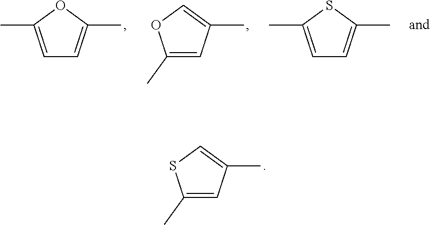

### Optionally,

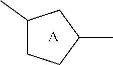

is independently selected from

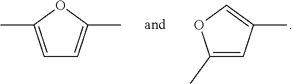

In some embodiments, the first compound has a structure represented by at least one of formulas IA-1 to IA-67:

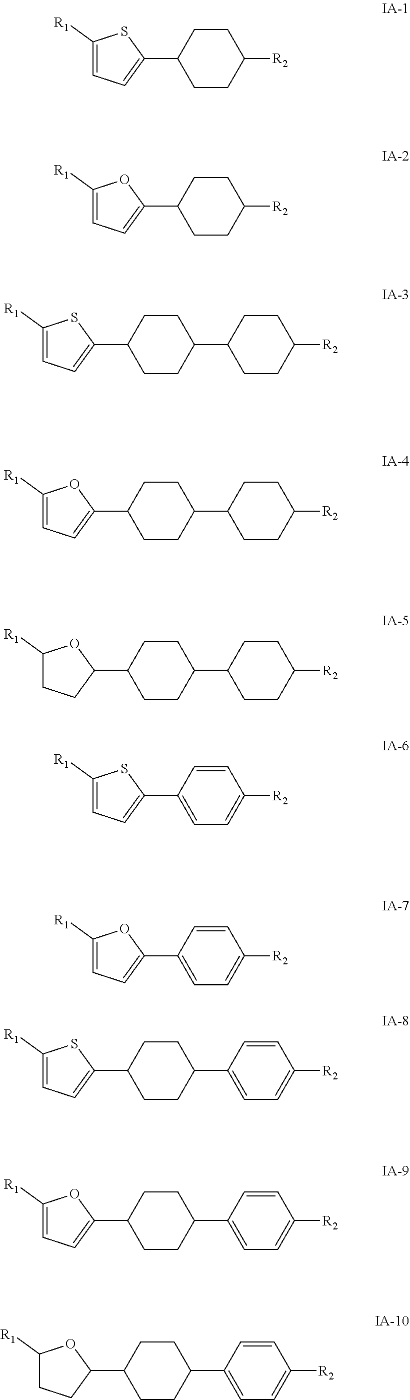

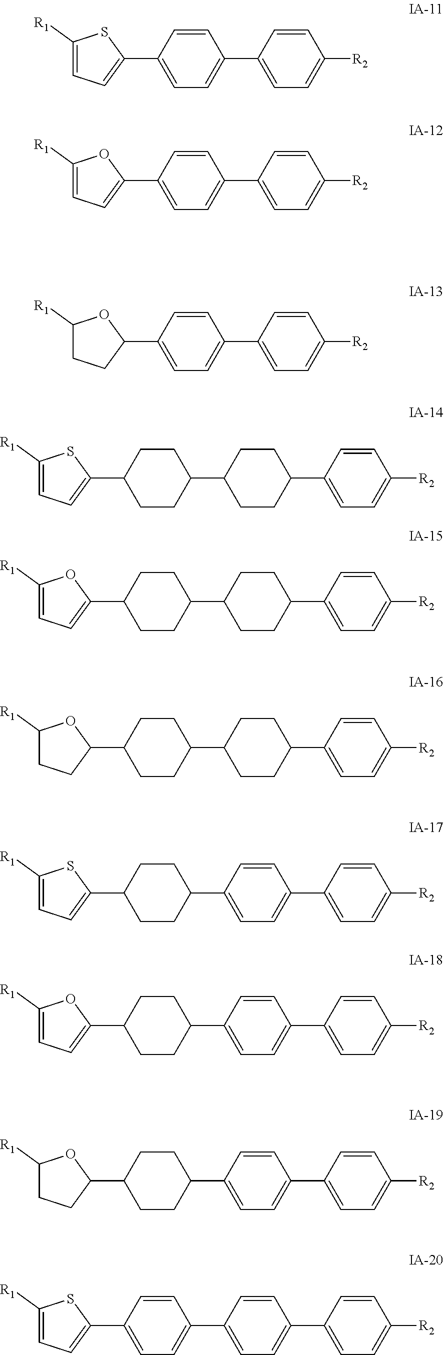

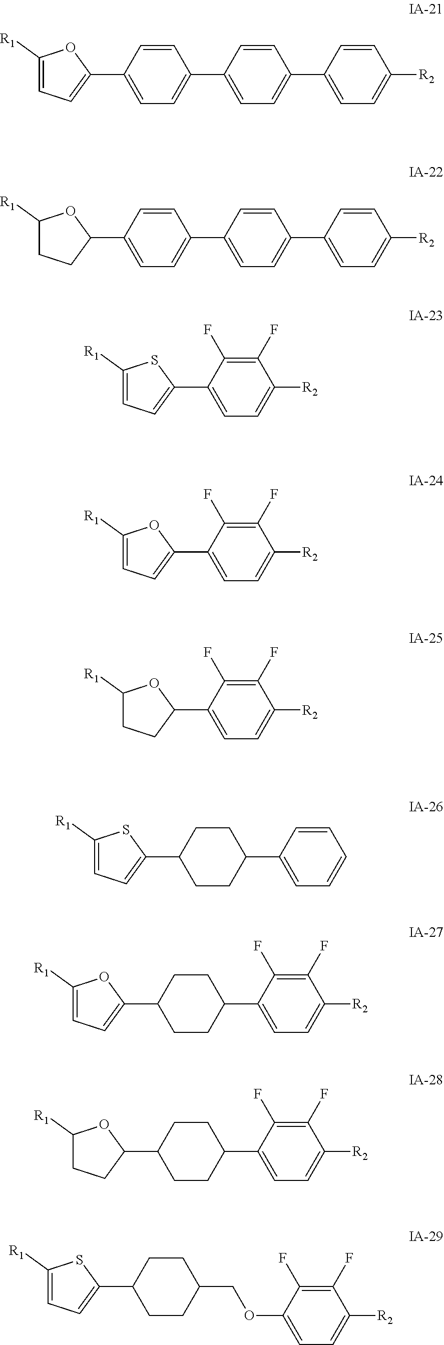

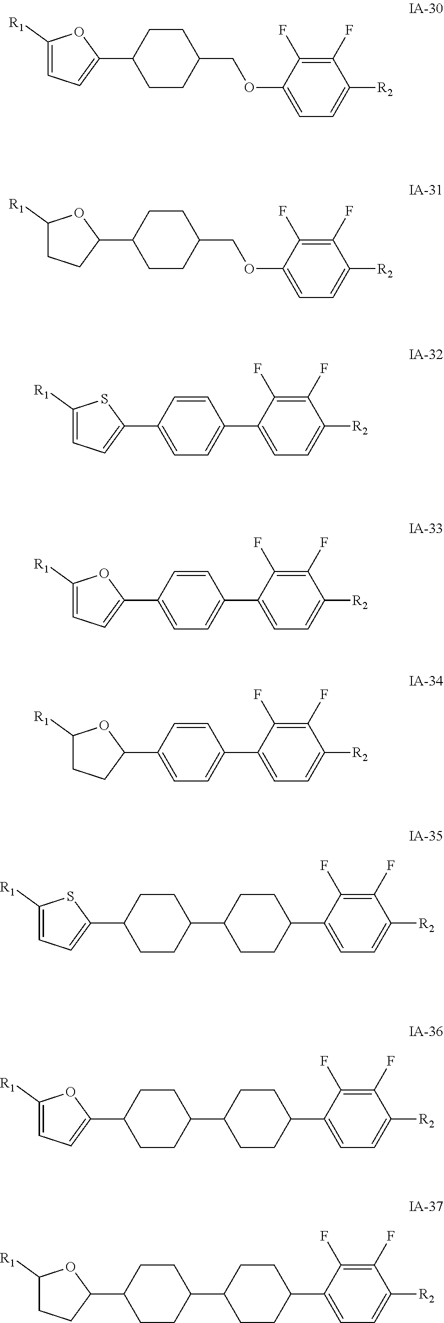

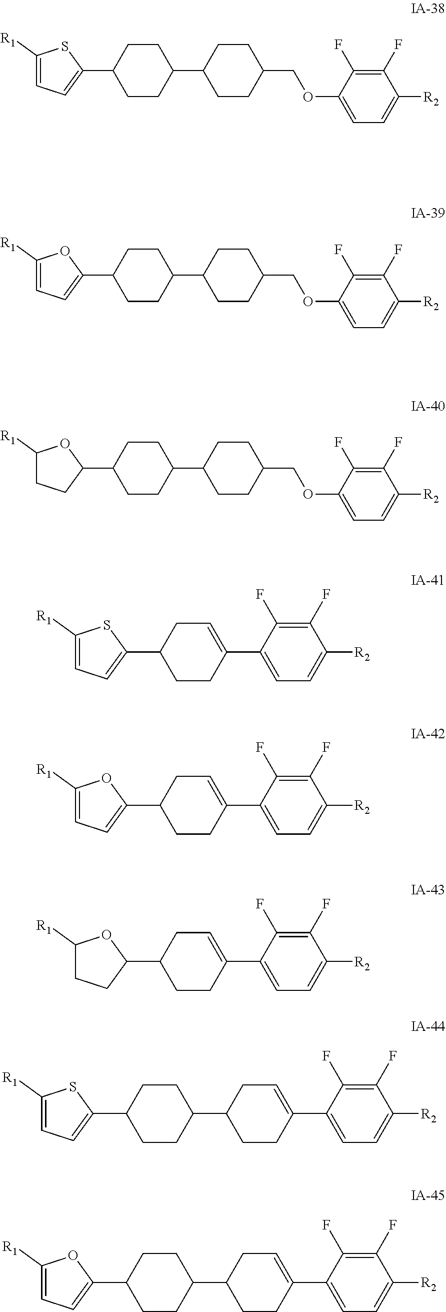

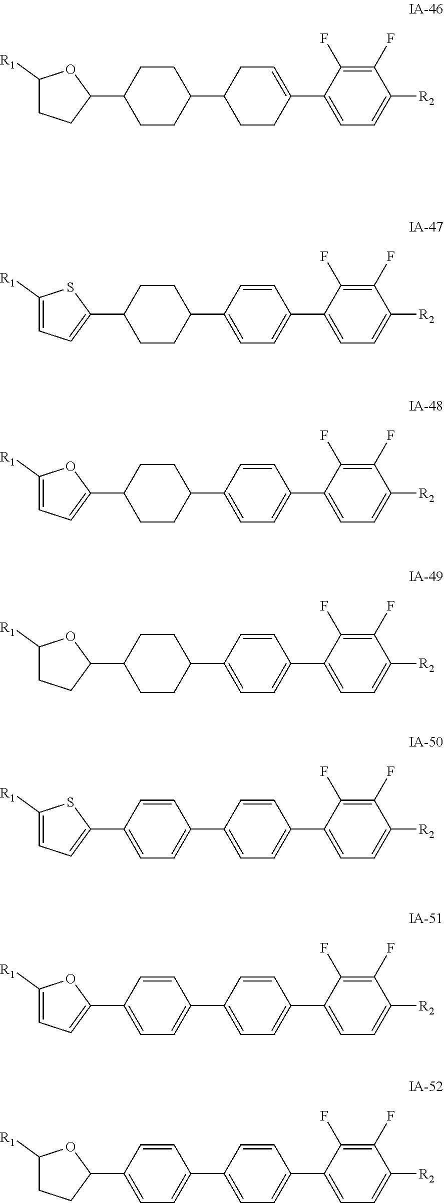

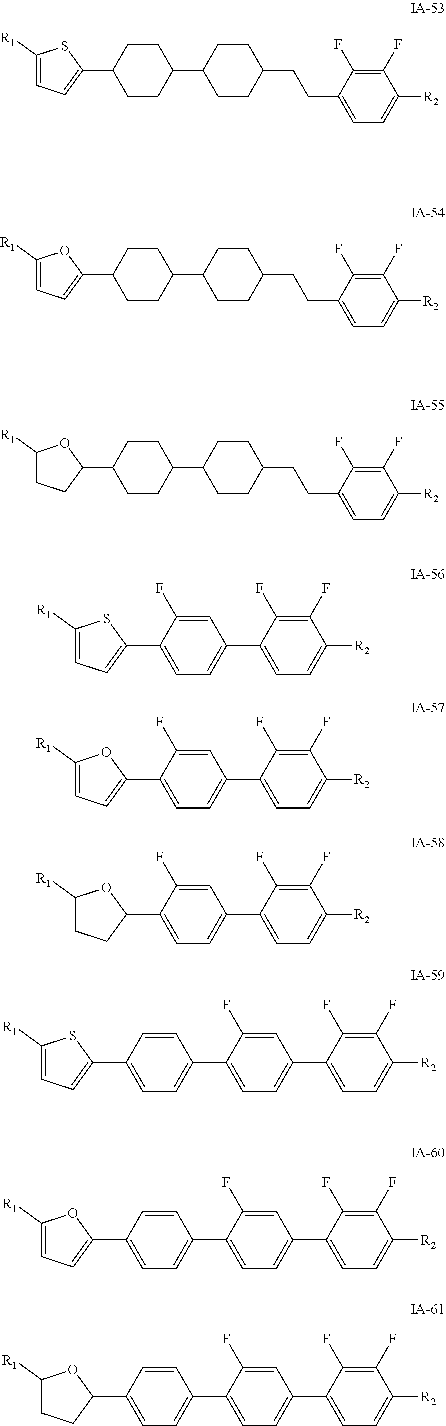

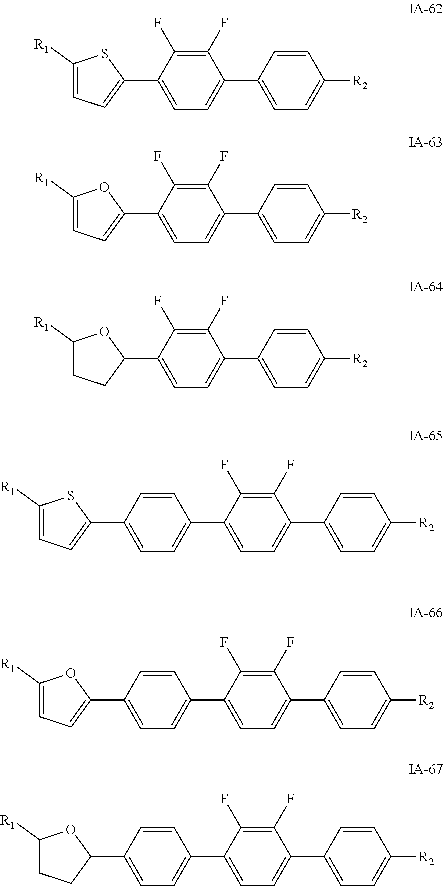

In some embodiments, the liquid crystal composition further includes at least one second compound with a structure represented by at least one of formulas II-1 to II-9:

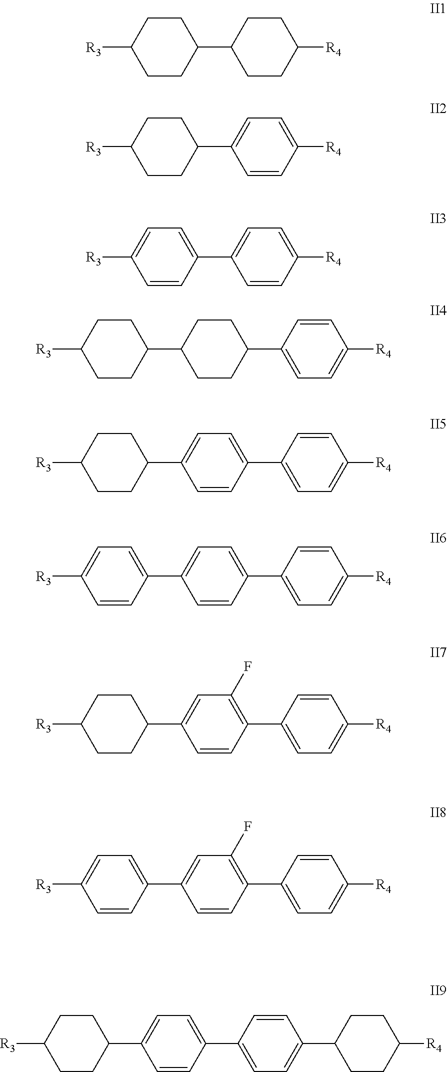

wherein R₃ and R₄ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or an unsubstituted alkenyloxy having 2 to 10 carbon atoms, a substituted or an unsubstituted alkynyl having 2 to 10 carbon atoms, and substituted or unsubstituted alkynyloxy having 2 to 10 carbon atoms, and H in R₃ and R₄ is unsubstituted or at least one H is substituted by any one of F, Cl, Br and I. That is, H in R₃ is unsubstituted or at least one H is substituted with any one of F, CI, Br and I, and H in R₄ is unsubstituted or at least one H is substituted with any one of F, CI, Br and I.

The second compound is a dielectric neutral compound, and the viscosity, clearing point, dielectric anisotropy, optical anisotropy, elastic coefficient, and the like of the liquid crystal composition are comprehensively adjusted, so that the liquid crystal composition is suitable for display panels.

In some embodiments, R₃ and R₄ are each independently selected from a substituted or an unsubstituted alkyl having 1 to 7 carbon atoms, a substituted or an unsubstituted alkoxy having 1 to 7 carbon atoms, and a substituted or an unsubstituted alkenyl having 2 to 7 carbon atoms.

Exemplarily, R₃ and R₄ are each independently selected from an unsubstituted alkyl having 1 to 7 carbon atoms, an unsubstituted alkoxy having 1 to 7 carbon atoms, and an unsubstituted alkenyl having 2 to 7 carbon atoms.

Exemplarily, R₃ and R₄ are each independently selected from an unsubstituted alkyl having 1 to 5 carbon atoms, an unsubstituted alkoxy having 1 to 5 carbon atoms, and an unsubstituted alkenyl having 2 to 5 carbon atoms.

In some embodiments, in a case that R₃ and R₄ are each independently selected from an unsubstituted alkyl, the unsubstituted alkyl may be an unsubstituted linear alkyl or an unsubstituted branched alkyl, optionally an unsubstituted linear alkyl. R₃ and R₄ are each independently selected from an unsubstituted linear alkyl having 1 to 7 carbon atoms, and may be selected from, for example, methyl, ethyl, propyl, butyl, pentyl, hexyl or heptyl.

In a case that R₃ and R₄ are each independently selected from an unsubstituted alkenyl, the unsubstituted alkenyl may be an unsubstituted linear alkenyl or an unsubstituted branched alkenyl, and the alkenyl may be an isomer in the E configuration and the Z configuration, and has at least one carbon-carbon double bond, and may be selected from an unsubstituted linear alkenyl, such as having 2 to 7 carbon atoms, optionally an ethenyl, prop-1-enyl, prop-2-enyl, but-1-enyl, a but-2-enyl, a but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-4-enyl, hept-5-enyl, hept-6-enyl, and the like.

In some embodiments, the liquid crystal composition further includes at least one third compound with a structure represented by at least one of formulas III-1 to III-5:

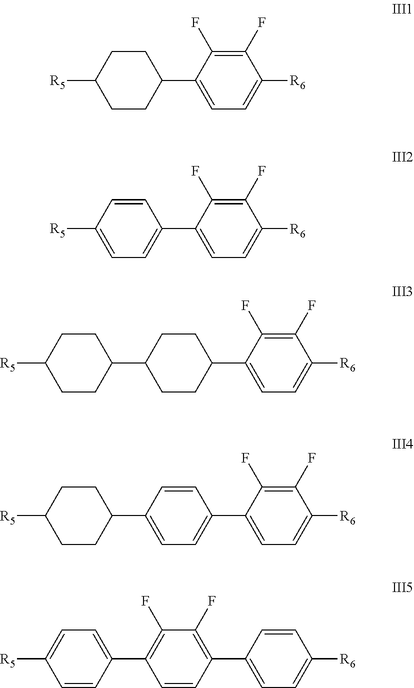

wherein R₅ and R₆ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or unsubstituted alkenyloxy having 2 to 10 carbon atoms, a substituted or unsubstituted alkynyl having 2 to 10 carbon atoms, and a substituted or unsubstituted alkynyloxy having 2 to 10 carbon atoms, and H in R₅ and R₆ is unsubstituted or at least one H is substituted with any one of F, Cl, Br, I, CH₃ and CN. That is, H in R₅ is unsubstituted or at least one H is substituted with any one of F, CI, Br, I, CH₃ or CN, and H in R₆ is unsubstituted or at least one H is substituted with any one of the atoms or groups in F, CI, Br, I, CH₃ or CN.

The third compound is a dielectric negative compound, and the dielectric negative compound and the dielectric neutral compound of the liquid crystal composition are mixed in proportions to comprehensively adjust the viscosity, the clearing point, the dielectric anisotropy, the optical anisotropy, the elastic coefficient, and the like of the liquid crystal composition, so that the liquid crystal composition is suitable for display panels.

In some embodiments, R₅ and R₆ are each independently selected from a substituted or an unsubstituted alkyl having 1 to 7 carbon atoms, a substituted or an unsubstituted alkoxy having 1 to 7 carbon atoms, and a substituted or an unsubstituted alkenyl having 2 to 7 carbon atoms.

Exemplarily, R₅ and R₆ are each independently selected from an unsubstituted alkyl having 1 to 7 carbon atoms, an unsubstituted alkoxy having 1 to 7 carbon atoms, and an unsubstituted alkenyl having 2 to 7 carbon atoms.

Exemplarily, R₅ and R₆ are each independently selected from an unsubstituted alkyl having 1 to 5 carbon atoms, an unsubstituted alkoxy having 1 to 5 carbon atoms, and an unsubstituted alkenyl having 2 to 5 carbon atoms.

In some embodiments, in a case that R₅ and R₆ are each independently selected from an unsubstituted alkyl, the unsubstituted alkyl may be an unsubstituted linear alkyl or an unsubstituted branched alkyl, optionally an unsubstituted linear alkyl. R₅ and R₆ are each independently selected from an unsubstituted linear alkyl having 1 to 7 carbon atoms, and may be selected from, for example, methyl, ethyl, propyl, butyl, pentyl, hexyl or heptyl.

In a case that R₅ and R₆ are each independently selected from an unsubstituted alkenyl, the unsubstituted alkenyl may be an unsubstituted linear alkenyl or unsubstituted branched alkenyl, and the alkenyl may be an isomer in the E configuration and the Z configuration, and has at least one carbon-carbon double bond, and may be selected from an unsubstituted linear alkenyl, such as having 2 to 7 carbon atoms, optionally ethenyl, prop-1-enyl, prop-2-enyl, but-1-enyl, a but-2-enyl, a but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-4-enyl, hept-5-enyl, hept-6-enyl, and the like.

In some embodiments, in the liquid crystal composition, the mass fraction of the first compound is greater than or equal to 1%, and the mass fraction of the first compound is less than or equal to 70%, for example, the mass fraction of the first compound may be 5%, 10%, 15%, 20%, 25%, 30%, 35%, 40%, 45%, 50%, 55%, 60%, 65%, and the like. In the liquid crystal composition, the mass fraction of the second compound is greater than or equal to 10%, and the mass fraction of the second compound is less than or equal to 70%, for example, the mass fraction of the second compound may be 5%, 10%, 15%, 20%, 25%, 30%, 35%, 40%, 45%, 50%, 55%, 60%, 65%, and the like. In the liquid crystal composition, the mass fraction of the third compound is greater than or equal to 10%, and the mass fraction of the third compound is less than or equal to 70%, for example, the mass fraction of the third compound may be 5%, 10%, 15%, 20%, 25%, 30%, 35%, 40%, 45%, 50%, 55%, 60%, 65%, and the like.

Exemplarily, in the liquid crystal composition, the mass fraction of the first compound is greater than or equal to 1% and the mass fraction of the first compound is less than or equal to 50%, for example, the mass fraction of the first compound may be 5%, 10%, 15%, 20%, 25%, 30%, 35%, 40%, 45%, and the like. In the liquid crystal composition, the mass fraction of the second compound is greater than or equal to 10%, and the mass fraction of the second compound is less than or equal to 60%, for example, the mass fraction of the second compound may be 15%, 20%, 25%, 30%, 35%, 40%, 45%, 50%, 55%, and the like. In the liquid crystal composition, the mass fraction of the third compound is greater than or equal to 10%, and the mass fraction of the third compound is less than or equal to 50%, for example, the mass fraction of the third compound may be 15%, 20%, 25%, 30%, 35%, 40%, 45%, and the like.

Exemplarily, in the liquid crystal composition, the mass fraction of the first compound is greater than or equal to 1%, and the mass fraction of the first compound is less than or equal to 40%, for example, the mass fraction of the first compound may be 5%, 10%, 15%, 20%, 25%, 30%, 35%, and the like. In the liquid crystal composition, the mass fraction of the second compound is greater than or equal to 10%, and the mass fraction of the second compound is less than or equal to 50%, for example, the mass fraction of the second compound may be 15%, 20%, 25%, 30%, 35%, 40%, 45%, and the like. In the liquid crystal composition, the mass fraction of the third compound is greater than or equal to 10%, and the mass fraction of the third compound is less than or equal to 50%, for example, the mass fraction of the third compound may be 15%, 20%, 25%, 30%, 35%, 40%, 45%, and the like.

In some embodiments, the difference in birefringence of the liquid crystal composition at 25° C. is greater than or equal to 0.1, and the difference in birefringence of the liquid crystal composition at 25° C. is less than or equal to 0.22, for example, it may be 0.105, 0.11, 0.115, 0.12, 0.125, 0.15, 0.175, 0.2, 0.21, etc., so that the difference in birefringence of the liquid crystal composition is within a suitable range, the light transmittance of the liquid crystal composition is improved, the light transmittance of the liquid crystal composition is within a suitable range, and the difference in birefringence of the liquid crystal composition is prevented from affecting the optical performance of the liquid crystal composition.

In some embodiments, the rotational viscosity of the liquid crystal composition at 25° C. is greater than or equal to 100 mPa·s, and rotational viscosity of the liquid crystal composition at 25° C. is less than or equal to 200 mPa·s, for example, it may be 110 mPa·s, 115 mPa·s, 120 mPa·s, 130 mPa·s, 140 mPa·s, 150 mPa·s, 160 mPa·s, 170 mPa·s, 180 mPa·s, 190 mPa·s, and the like, so that the rotational viscosity of the liquid crystal composition is within a suitable range, the rotational speed of the liquid crystal composition is increased, the response time of the liquid crystal composition is within a suitable range, and the rotational viscosity of the liquid crystal composition is prevented from affecting the performance of the liquid crystal composition.

In some embodiments, the bending elastic coefficient of the liquid crystal composition is greater than or equal to 10, and the bending elastic coefficient of the liquid crystal composition is less than or equal to 26, for example, it may be 11, 12, 13, 14, 15, 18, 20, 22, 24, 25, and the like; and/or the splay elastic coefficient of the liquid crystal composition is greater than or equal to 10, and the splay elastic coefficient of the liquid crystal composition is less than or equal to 26, for example, it may be 12, 13, 14, 15, 18, 20, 22, 24, 25, and the like. In a case that the bending elastic coefficient of the liquid crystal composition and/or the splay elastic coefficient of the liquid crystal composition are in the above-mentioned range, it is beneficial for the liquid crystal composition to obtain an appropriate average value of elastic coefficient, thereby effectively improving the light leakage problem in dark state of the display panel in a case that the liquid crystal composition is applied to a display surface.

In some embodiments, the dielectric constant anisotropy value of the liquid crystal composition at 25° C. is greater than or equal to −10, and the dielectric constant anisotropy value of the liquid crystal composition at 25° C. is less than or equal to −1, for example, it may be −8, −6, −5, −4.2, −4.1, −4, −3.8, −3.7, −3.4, −3.2, −3, −2, −1.5, and the like, which is beneficial to reduce the driving voltage required to drive the liquid crystal composition, thereby reducing the driving voltage of the liquid crystal display panel using the liquid crystal composition and reducing the power consumption of the liquid crystal display panel using the liquid crystal composition.

In some embodiments, the clearing point of the liquid crystal composition exemplarily ranges from 60° C. to 135° C., for example, the clearing point of the liquid crystal composition may be 62° C., 65° C., 68° C., 70° C., 75° C., 77° C., 78° C., 80° C., 82° C., 84° C., 88° C., 90° C., 92° C., 95° C. to avoid reduction of the high temperature resistance of the liquid crystal composition caused by low clearing point of the liquid crystal composition.

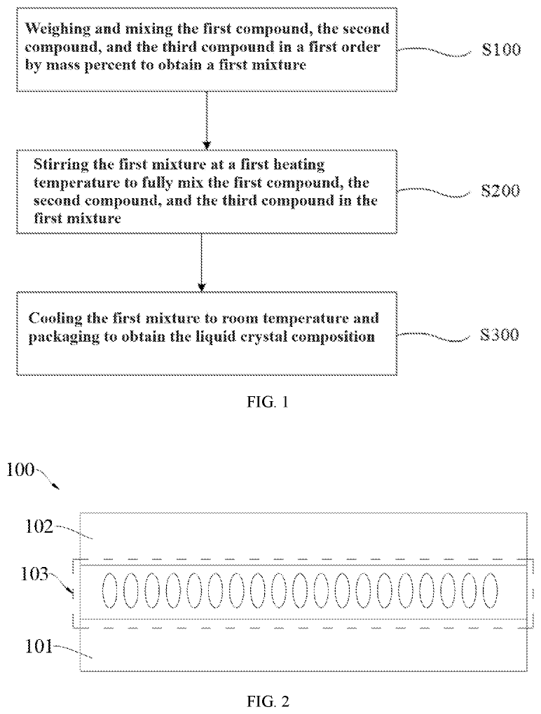

Referring to FIG. 1, an exemplary preparation method of the liquid crystal composition provided by the present disclosure is as follows:

A preparation method of the liquid crystal composition includes steps as follows:
S100, weighing and mixing the first compound, the second compound, and the third compound in a first order by mass percent to obtain a first mixture;
wherein the S100 is optionally carried out by weighing and mixing the first compound, the second compound, and the third compound are weighed and mixed sequentially in an order of melting point from low to high;
S200, stirring the first mixture at a first heating temperature to fully mix the first compound, the second compound, and the third compound in the first mixture;
wherein the first heating temperature is optionally from 60° C. to 100° C.;
S300, cooling the first mixture to room temperature and packaging to obtain the liquid crystal composition.

Exemplary combinations of the liquid crystal compositions of the present disclosure are shown below in exemplary Examples 1 to 5.

### Example 1

The structural formula and mass fractions of each compound in the liquid crystal composition selected in this example are shown in Table 1:

TABLE 1
Components of liquid crystal compositions

| Structural formula | Mass fraction/% |
|---|---|
| 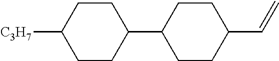 | 30 |
| 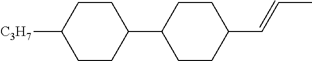 | 6 |
| 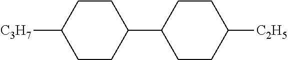 | 2 |
| 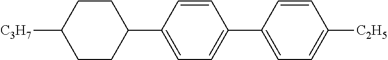 | 5 |
| 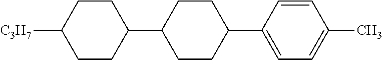 | 5 |
| 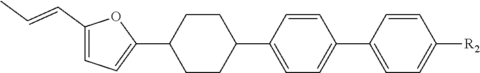 | 2 |
| 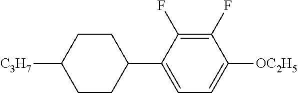 | 10 |
| 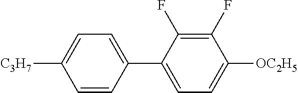 | 10 |
| 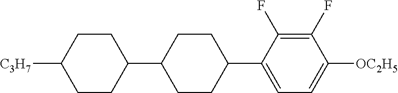 | 8 |
| 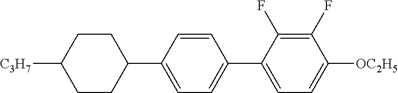 | 8 |
| 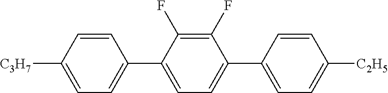 | 7 |
| 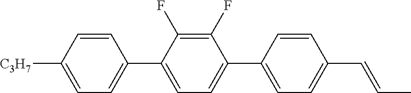 | 7 |

The performance parameters of the liquid crystal composition obtained in Example 1 are as follows: Tni: 77° C., γ₁: 133 mPa·s, Δn: 0.1120, ne: 1.642, Δ_{ε}: −2.4, ε_{⊥}: 5.3, K₁₁: 17.3, K₃₃: 22.3, no crystals are precipitated from the liquid crystal composition when placed at −20° C. for 480 hours. Tni represents the clearing point of the liquid crystal composition; γᵢ represents the rotational viscosity of the liquid crystal composition at 25° C.; Δn is the difference in birefringence of the liquid crystal composition at 25° C., indicating the optical anisotropy of the liquid crystal composition, and ne represents the refractive index of extraordinary light of the liquid crystal composition; ΔE represents the dielectric constant anisotropy value of the liquid crystal composition at 25° C.; ε_{⊥} represents a dielectric constant value of the liquid crystal composition in a direction perpendicular to the long axis of the liquid crystal molecules; K₁₁ represents the bending elastic coefficient of the liquid crystal composition, and K₃₃ represents the splay elastic coefficient of the liquid crystal composition.

### Example 2

The structural formula and mass fractions of each compound in the liquid crystal composition selected in this example are shown in Table 2:

TABLE 2
Components of liquid crystal compositions

| Structural formula | Mass fraction/% |
|---|---|
| 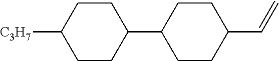 | 25 |
| 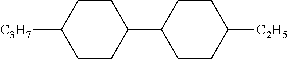 | 10 |
| 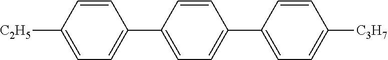 | 5 |
| 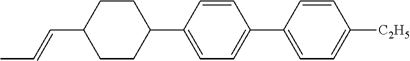 [SMILES: C/C=C/C1CCC(c2ccc(-c3ccc(CC)cc3)cc2)CC1] | 8 |
| 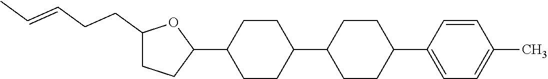 [SMILES: C/C=C/CCC1CCC(C2CCC(C3CCC(c4ccc(C)cc4)CC3)CC2)O1] | 6 |
| 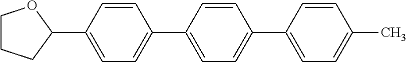 [SMILES: Cc1ccc(-c2ccc(-c3ccc(C4CCCO4)cc3)cc2)cc1] | 6 |
| 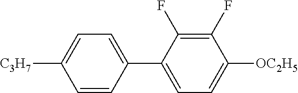 | 7 |
| 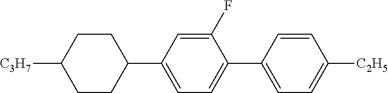 | 5 |
| 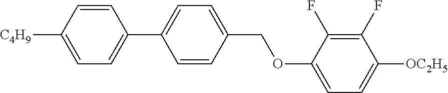 | 5 |
| 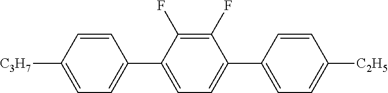 | 5 |
| 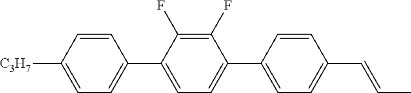 | 5 |
| 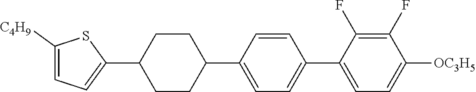 | 5 |
| 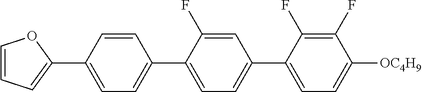 | 8 |

The performance parameters of the liquid crystal composition obtained in Example 2 are as follows: Tni: 101° C., γ₁: 146 mPa·s, Δn: 0.137, ne: 1.782, Δ_{ε}: −2.0, ε_{⊥}: 4.8, K₁₁: 25.9, K₃₃: 21.8, no crystals are precipitated from the liquid crystal composition when placed at −20° C. for 480 hours.

### Example 3

The structural formula and mass fractions of each compound in the liquid crystal composition selected in this example are shown in Table 3:

TABLE 3
Components of liquid crystal compositions

| | Mass fraction/ |
|---|---|
| Structural formula | % |
| 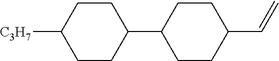 | 30 |
| 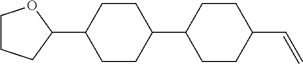 [SMILES: C=CC1CCC(C2CCC(C3CCCO3)CC2)CC1] | 8 |
| 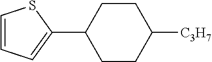 | 8 |
| 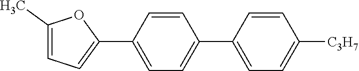 | 3 |
| 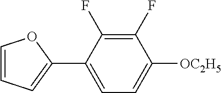 [SMILES: CCOc1ccc(-c2ccco2)c(F)c1F] | 15 |
| 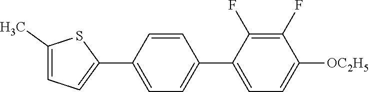 [SMILES: CCOc1ccc(-c2ccc(-c3ccc(C)s3)cc2)c(F)c1F] | 5 |
| 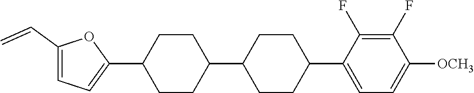 [SMILES: C=Cc1ccc(C2CCC(C3CCC(c4ccc(OC)c(F)c4F)CC3)CC2)o1] | 2 |
| 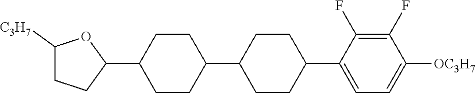 | 2 |
| 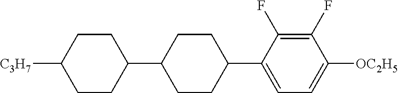 | 3 |
| 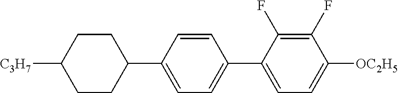 | 4 |
| 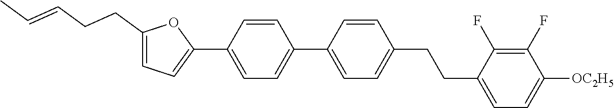 [SMILES: C/C=C/CCc1ccc(-c2ccc(-c3ccc(CCc4ccc(OCC)c(F)c4F)cc3)cc2)o1] | 2 |
| 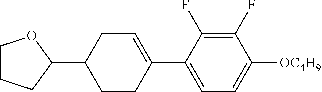 | 10 |
| 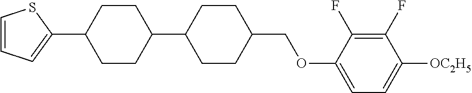 [SMILES: CCOc1ccc(OCC2CCC(C3CCC(c4cccs4)CC3)CC2)c(F)c1F] | 2 |
| 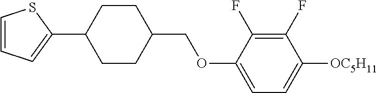 | 6 |

The performance parameters of the liquid crystal composition obtained in Example 3 are as follows: Tni: 76° C., γᵢ: 153 mPa·s, Δn: 0.1043, ne: 1.5832, Δ_{ε}: −3.1, ε_{⊥}: 6.2, K₁₁: 14.5, K₃₃: 21.6, no crystals are precipitated from the liquid crystal composition when placed at −20° C. for 480 hours.

### Example 4

The structural formula and mass fractions of each compound in the liquid crystal composition selected in this example are shown in Table 4:

TABLE 4
Components of liquid crystal compositions

| Structural formula | Mass fraction/% |
|---|---|
| 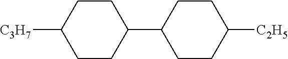 | 16 |
| 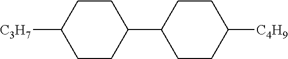 | 10 |
| 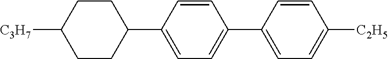 | 5 |
| 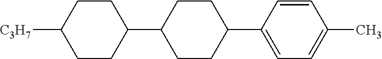 | 5 |
| 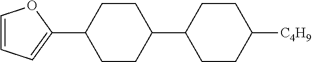 | 8 |
| 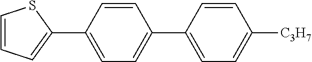 | 3 |
| 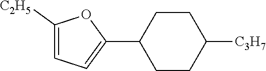 | 6 |
| 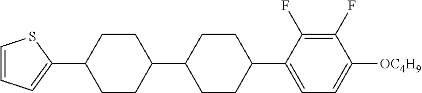 | 6 |
| 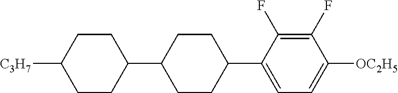 | 5 |
| 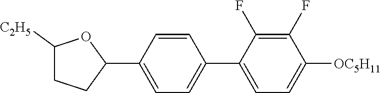 | 8 |
| 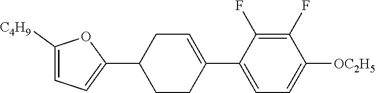 | 7 |
| 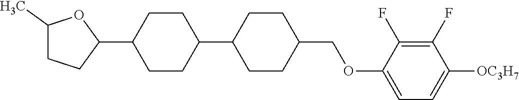 | 7 |
| 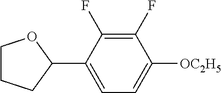 [SMILES: CCOc1ccc(C2CCCO2)c(F)c1F] | 6 |
| 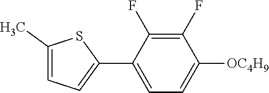 | 4 |
| 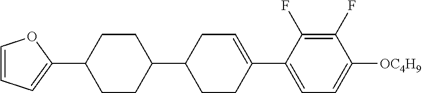 | 4 |

The performance parameters of the liquid crystal composition obtained in Example 4 are as follows: Tni: 105° C., γᵢ: 169 mPa·s, Δn: 0.1108, ne: 1.650, Δ_{ε}: −3.2, ε_{⊥}: 6.6, K₁₁: 18.7, K₃₃: 23.9, no crystals are precipitated from the liquid crystal composition when placed at −20° C. for 480 hours.

### Example 5

The structural formula and mass fractions of each compound in the liquid crystal composition selected in this example are shown in Table 5:

TABLE 5
Components of liquid crystal compositions

| Structural formula | Mass fraction/% |
|---|---|
| 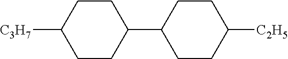 | 15 |
| 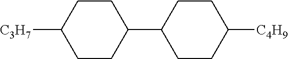 | 10 |
| 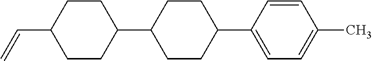 [SMILES: C=CC1CCC(C2CCC(c3ccc(C)cc3)CC2)CC1] | 8 |
| 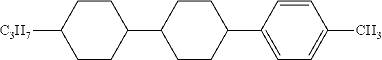 | 10 |
| 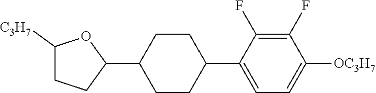 | 10 |
| 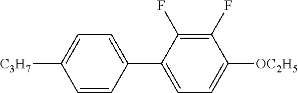 | 10 |
| 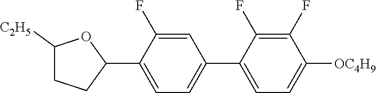 | 5 |
| 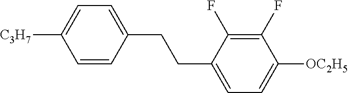 | 6 |
| 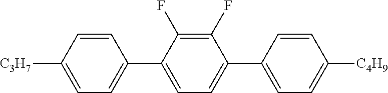 | 7 |
| 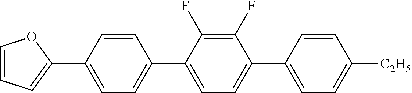 [SMILES: CCc1ccc(-c2ccc(-c3ccc(-c4ccco4)cc3)c(F)c2F)cc1] | 4 |
| 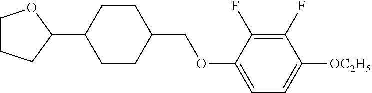 [SMILES: CCOc1ccc(OCC2CCC(C3CCCO3)CC2)c(F)c1F] | 6 |
| 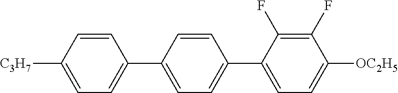 | 3 |
| 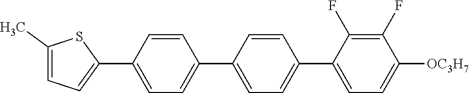 | 3 |
| 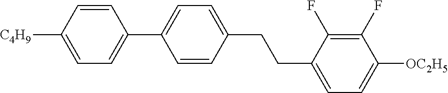 | 3 |

The performance parameters of the liquid crystal composition obtained in Example 5 are as follows: Tni: 77° C., γ₁: 104 mPa·s, Δn: 0.1141, ne: 1.685, Δ_{ε}: −3.4, ε_{⊥}: 7.0, K₁₁: 15.8, K₃₃: 19.6, no crystals are precipitated from the liquid crystal composition when placed at −20° C. for 480 hours.

Comparative Example 1

| Structural formula | Mass fraction/% |
|---|---|
| 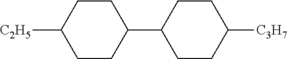 | 16 |
| 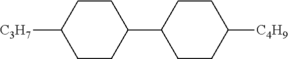 | 10 |
| 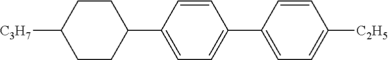 | 5 |
| 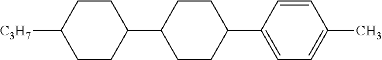 | 5 |
| 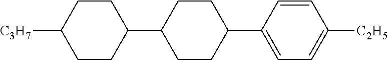 | 8 |
| 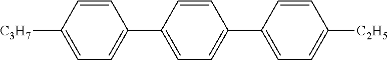 | 3 |
| 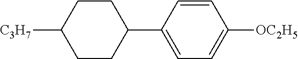 | 6 |
| 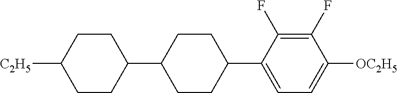 [SMILES: CCOc1ccc(C2CCC(C3CCC(CC)CC3)CC2)c(F)c1F] | 6 |
| 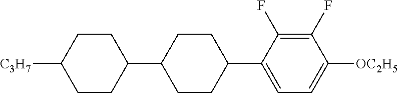 | 5 |
| 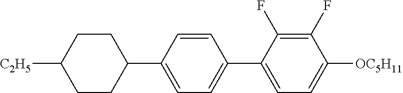 | 8 |
| 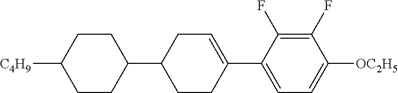 | 7 |
| 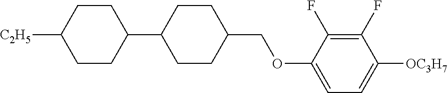 | 7 |
| 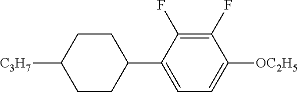 | 6 |
| 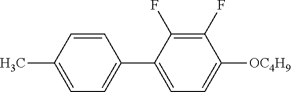 | 4 |
| 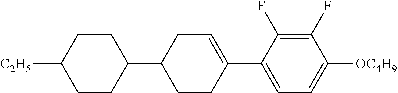 | 4 |

The performance parameters of the liquid crystal composition obtained in Comparative Example 1 are as follows: Tni: 95° C., γᵢ: 145 mPa·s, Δn: 0.1062, ne: 1.593, Δ_{ε}: −3.0, ε_{⊥}: 6.1, K₁₁: 16.8, K₃₃: 19.2, no crystals are precipitated from the liquid crystal composition when placed at −20° C. for 480 hours

According to the five groups of liquid crystal compositions provided in the above Examples 1 to 5, the clearing point in each group is between 76° C. and 105° C., so that the liquid crystal composition has good high temperature resistance; the rotational viscosity at 25° C. in each group is between 104 mPa·s and 169 mPa·s, so that the liquid crystal composition has good rotational speed, which is beneficial to shortening the response time of the liquid crystal composition; the difference in birefringence at 25° C. in each group is between 0.1043 and 0.137, so that the liquid crystal composition has good light transmittance; the dielectric constant anisotropy value at 25° C. in each group is between −3.4 and −2, which is beneficial to driving the liquid crystal composition at a lower driving voltage, thereby reducing power consumption of display panels using the liquid crystal composition; the bending elastic coefficient of the liquid crystal composition is between 14.5 and 25.9, and the splay elastic coefficient is between 19.6 and 23.9, which is beneficial to improving the average elastic coefficient of the liquid crystal composition and effectively improving the light leakage problem in dark state of the display panel in a case that the liquid crystal composition is applied to the display surface. Referring to Example 4 and Comparative Example 1, compared with Comparative Example 1, in Example 4, by adding the first compound, the clearing point, bending elastic coefficient and splay elastic coefficient of the liquid crystal composition are effectively improved, and the performance of the liquid crystal composition is improved in terms of clearing point and elastic coefficient, which is beneficial to improving the display contrast and product quality of the display panel using the liquid crystal composition.

Referring to FIG. 2, an embodiment of the present disclosure further provides a display panel 100 including a first substrate 101, a second substrate 102 disposed on the first substrate 101, and a liquid crystal layer 103 disposed between the first substrate 101 and the second substrate 102. The liquid crystal layer 103 includes the liquid crystal composition as described above.

The first substrate 101 may be an array substrate, and the second substrate 102 may be a color filter substrate. In some embodiments, in a case that the first substrate 101 is an array substrate, the first substrate 101 includes a first substrate, an active layer disposed on the substrate, a first insulating layer disposed on the active layer, a gate layer disposed on the first insulating layer, a second insulating layer disposed on the gate layer, a source-drain layer disposed on the second insulating layer, and a third insulating layer disposed on the source-drain layer, wherein the source-drain layer includes a source and a drain. The display panel further includes a common electrode layer disposed on a side of the third insulating layer away from the first substrate, and a pixel electrode layer disposed on a side of the third insulating layer away from the first substrate, wherein the pixel electrode layer includes pixel electrodes electrically connected to the source or the drain. The common electrode layer includes a common electrode. The common electrode may be disposed on the first substrate 101. The common electrode layer is disposed between the pixel electrode layer and the source-drain layer, or the common electrode layer may be disposed on a side of the pixel electrode layer away from the first substrate. The common electrode layer may be provided with the second substrate 102. The second substrate 102 includes a second substrate, and the common electrode layer is disposed on a side of the second substrate close to the liquid crystal layer. The display panel further includes a color filter layer, which may be disposed on a side of the first substrate close to the liquid crystal layer or on a side of the second substrate close to the liquid crystal layer.

The display panel 100 may be a display panel in a display mode such as vertical alignment (VA), electrically controlled birefringence (ECB), fringe field switching (FFS), or in-plane switching (IPS).

According to the display panel provided in the present disclosure, by adding the first compound shown in formula (I) to the liquid crystal composition used in the liquid crystal layer, the performance of the liquid crystal composition is improved in terms of clearing point, elastic coefficient, and the like, thereby improving the display contrast and product quality of a display panel using the liquid crystal composition are improved.

Embodiments of the present disclosure discloses a liquid crystal composition and a display panel. The liquid crystal composition includes at least one first compound represented by formula (I). By adding the first compound to the liquid crystal composition, the performance of the liquid crystal composition is improved in terms of clearing point, elastic coefficient, and the like, thereby improving the display contrast and product quality of a display panel using the liquid crystal composition are improved.

In view of the foregoing, the liquid crystal composition and the display panel provided in examples of the present disclosure have been described in detail above, and the principles and embodiments of the present disclosure are described by using specific examples herein. Descriptions of the above examples are merely intended to help understand the technical solutions and core ideas of the present disclosure. A person with ordinary skill in the art should understand that various modifications may still be made to the technical solutions described in the foregoing examples, or equivalents may be made to some of the technical features therein. These modifications or substitutions do not depart the essence of the corresponding technical solutions from the scope of the technical solutions of the examples of the present disclosure.

1. A liquid crystal composition comprising at least a first compound represented by formula (I): 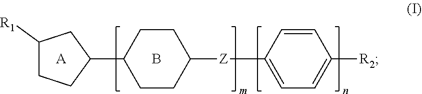
wherein, m and n are each independently selected from 0, 1, 2 and 3, and n and m are not both 0 at the same time; 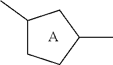
is independently selected from 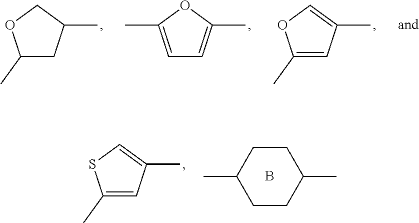
is independently selected from 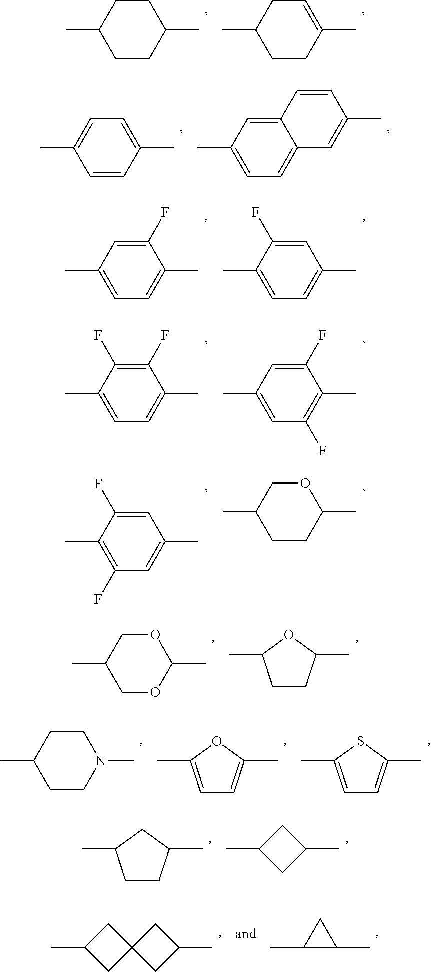
and at least one H in 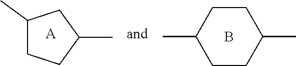
is replaced with any one of F, CI, Br, I and H;
Z is independently selected from a single bond, —O—, —C(O)O—, —OC(O)—, —CF₂O—, —OCF₂—, —CH₂CH₂—, —CF₂CF₂—, —CH₂O—, —OCH₂—, —CH═CH— or —C≡C—, and in a case that any Z is selected from a group with H, the H in any Z is unsubstituted or at least one H is substituted with any one of F, Cl, Br and I; and
R₁ and R₂ are each independently selected from H, F, Cl, Br, I, CN, SCN, NCS, SF₅, a substituted or an unsubstituted alkyl having 1 to 15 carbon atoms, a substituted or an unsubstituted alkoxy having 1 to 15 carbon atoms, a substituted or an unsubstituted alkenyl having 2 to 15 carbon atoms, a substituted or an unsubstituted alkenyloxy having 2 to 15 carbon atoms, a substituted or an unsubstituted alkynyl having 2 to 15 carbon atoms, and a substituted or an unsubstituted alkynyloxy having 2 to 15 carbon atoms.

2. The liquid crystal composition according to claim 1, wherein terminal groups of R₁ and R₂ selected from the substituted or the unsubstituted alkyl having 1 to 15 carbon atoms, the substituted or the unsubstituted alkoxy having 1 to 15 carbon atoms, the substituted or the unsubstituted alkenyl having 2 to 15 carbon atoms, the substituted or the unsubstituted alkenyloxy having 2 to 15 carbon atoms, the substituted or the unsubstituted alkynyl having 2 to 15 carbon atoms, and the substituted or the unsubstituted alkynyloxy having 2 to 15 carbon atoms are each independently monosubstituted with H, CN or CF₃; and/or,
one or more —CH₂— in R₁ and R₂ are each independently substituted with —O—, —S—, —SO₂—, —CO—, —C(O)O—, —OC(O)—, —OC(O)O—, —CF₂O—, —OCF₂—, —CH₂—CH₂—, —(CH₂)₃—, —CF₂—CF₂—, —CF₂—CH₂—, —CH₂—CF₂—, —CHF—CHF—, —CH₂O—, —OCH₂—, —CF═CH—, —CH═CF—, —CF═CF—, —CH═CH— or —C≡C—, and are not directly bonded to heteroatoms that are directly bonded to C, and H in R₁ and R₂ is unsubstituted or at least one H is substituted with any one of F, Cl, Br and I.

3. The liquid crystal composition according to claim 1, wherein the first compound has a structure represented by at least one of formulas I-1 to I-37:

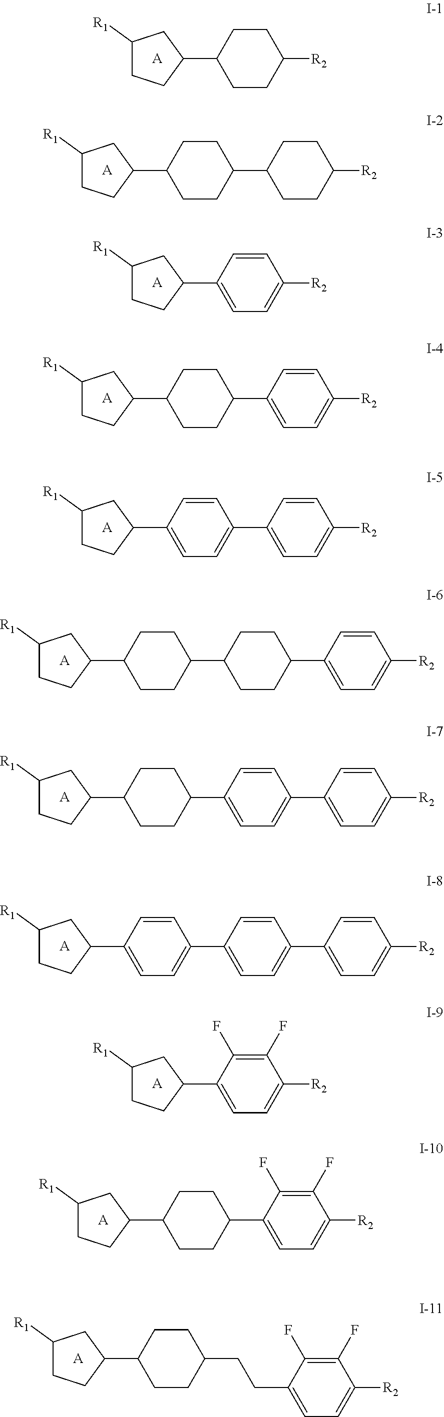

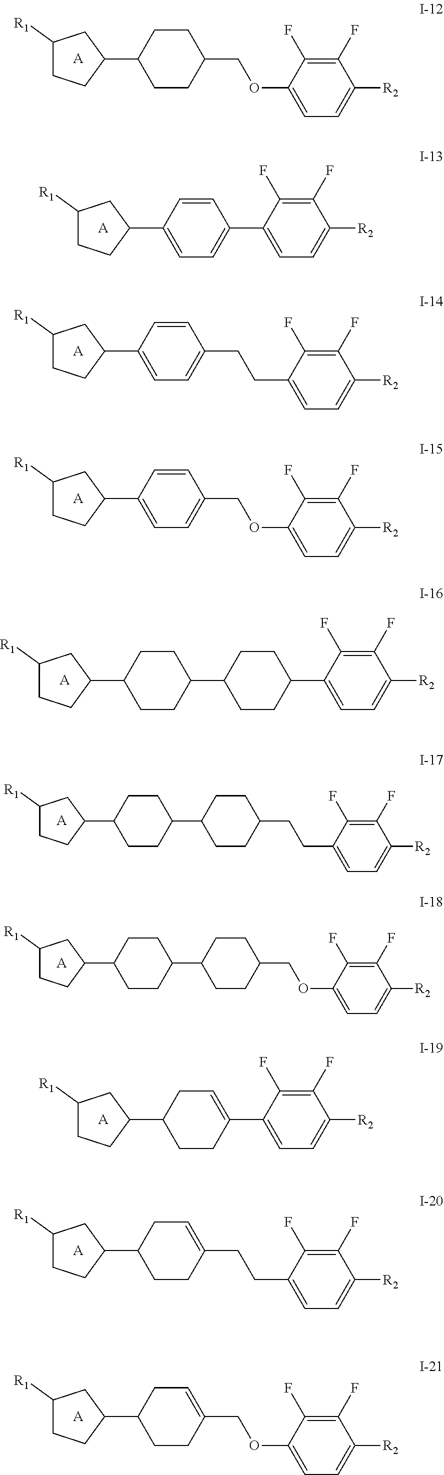

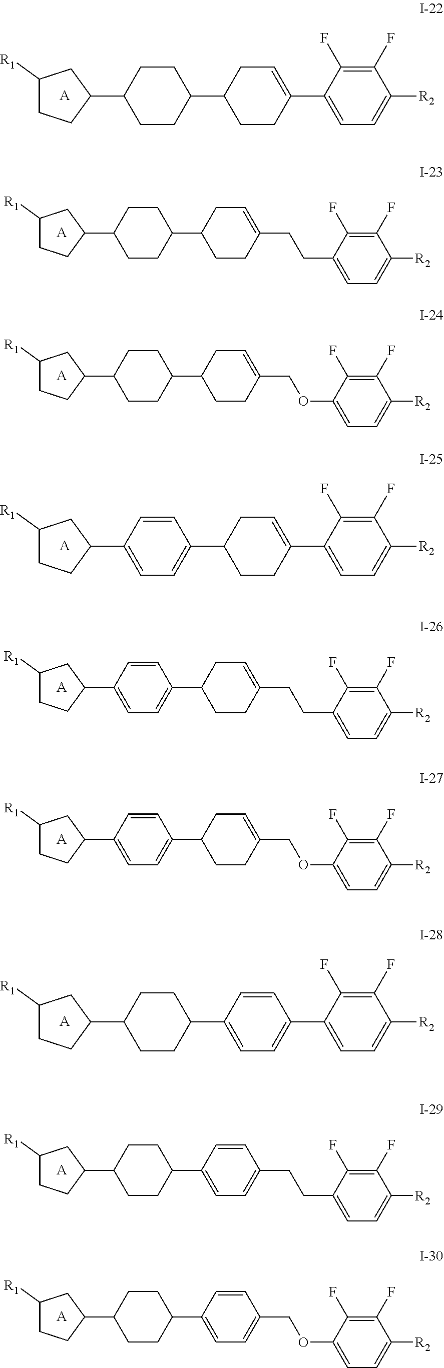

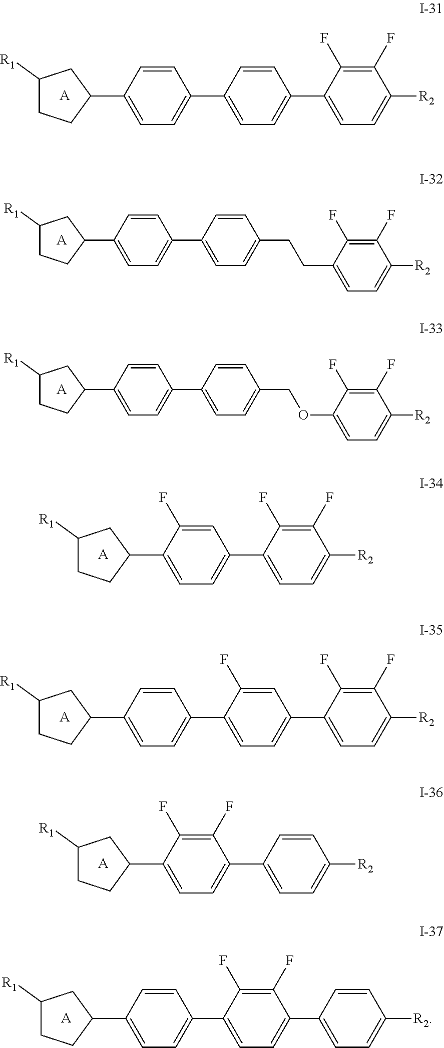

4. The liquid crystal composition according to claim 3, wherein 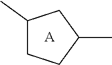
is independently selected from

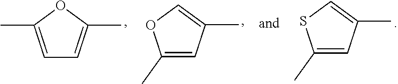

5. The liquid crystal composition according to claim 3, wherein the first compound has a structure represented by at least one of the following formulas:

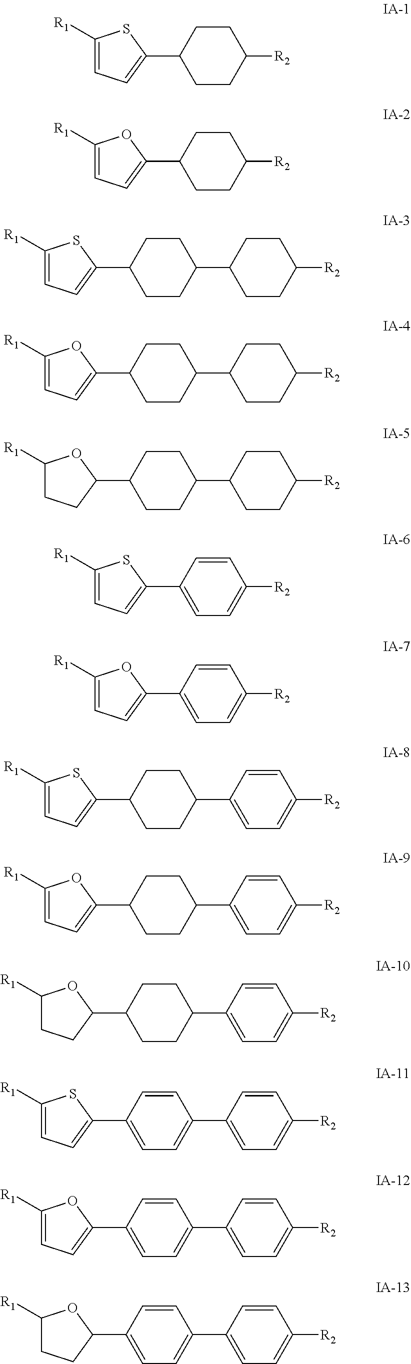

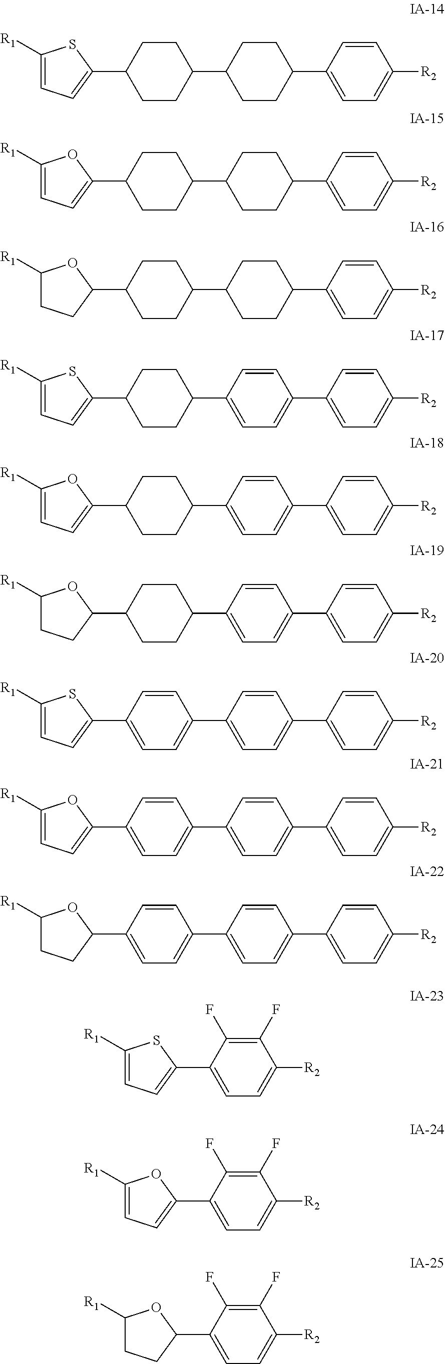

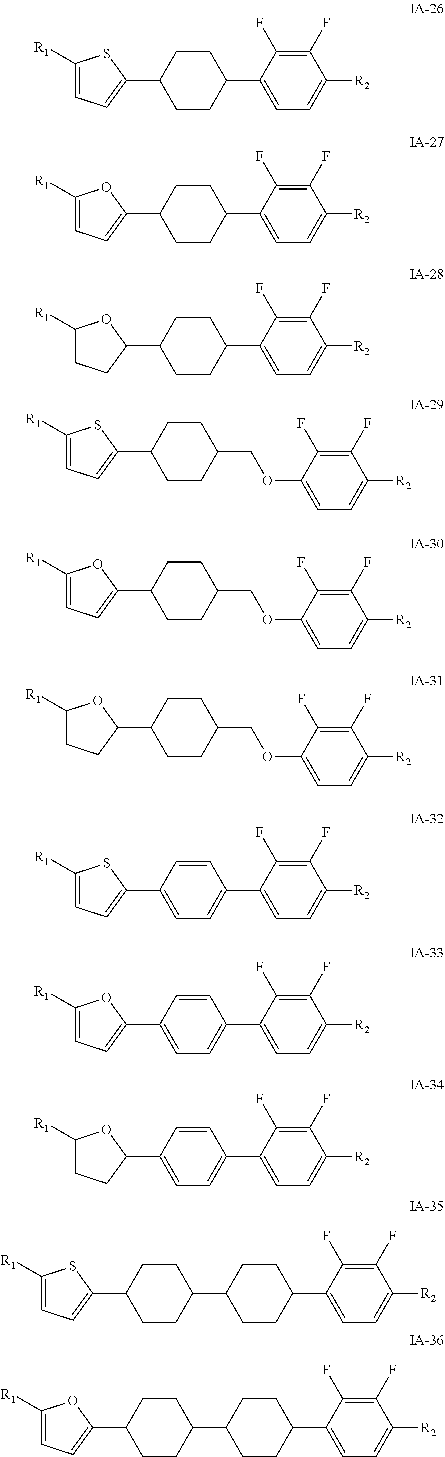

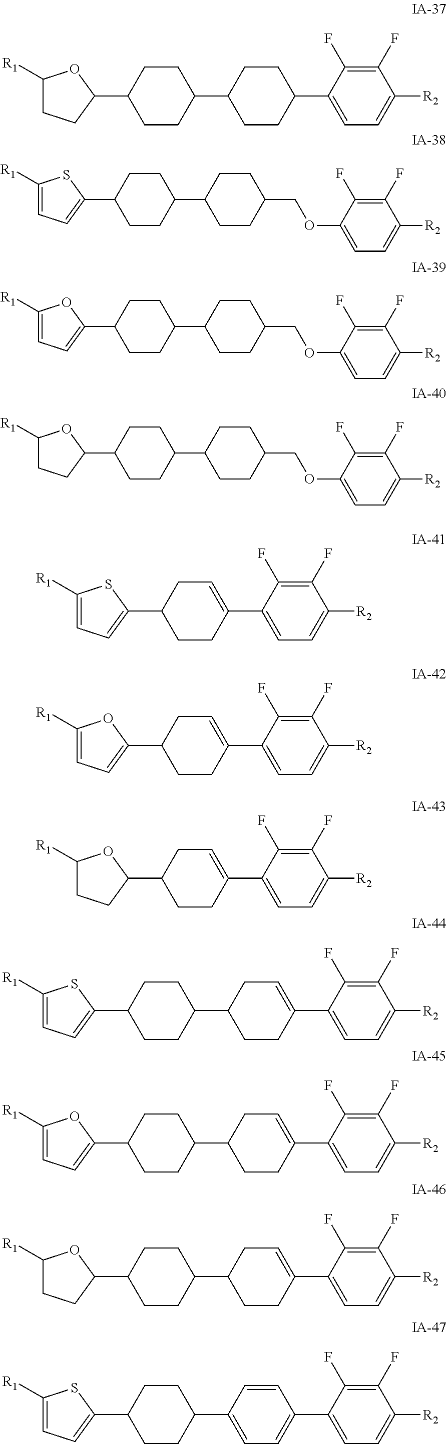

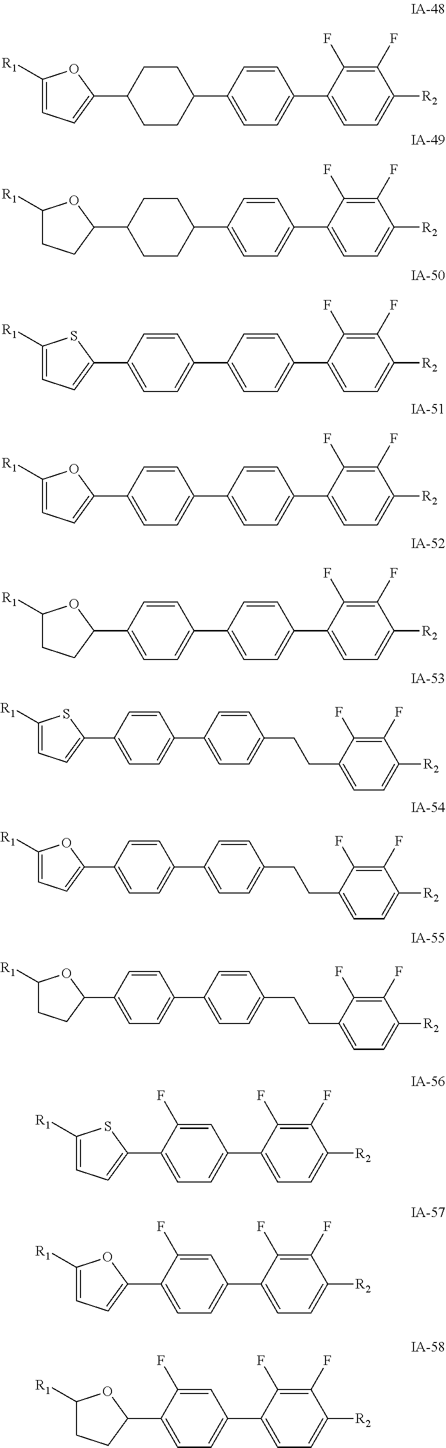

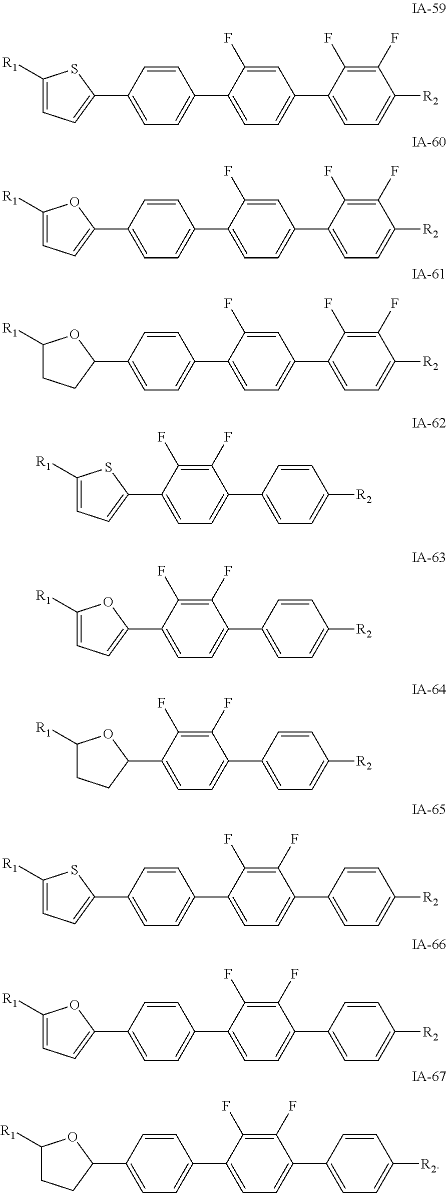

6. The liquid crystal composition according to claim 5, wherein R₁ and R₂ are each independently selected from H, F, an unsubstituted alkyl having 1 to 7 carbon atoms, an unsubstituted alkoxy having 1 to 7 carbon atoms, and an unsubstituted alkenyl having 2 to 7 carbon atoms.

7. The liquid crystal composition according to claim 1, further comprises at least a second compound with a structure represented by at least one of formulas II-1 to II-9: 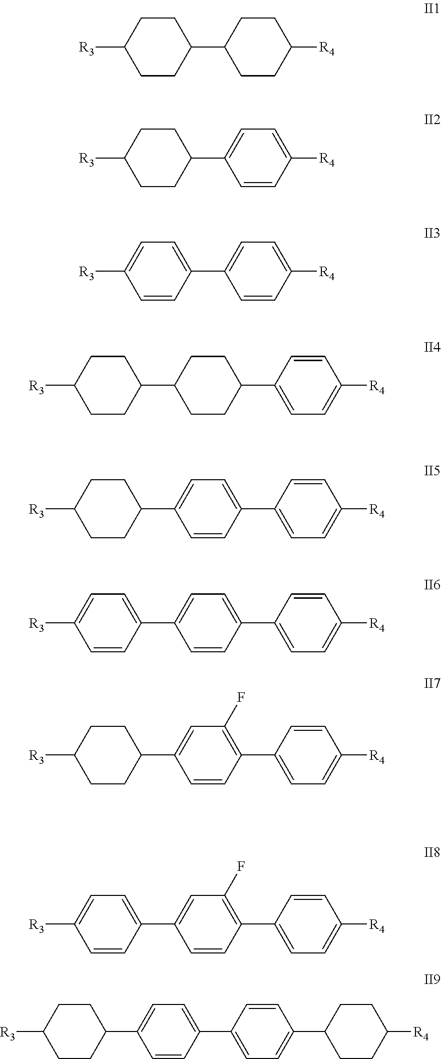
wherein R₃ and R₄ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or an unsubstituted alkenyloxy having 2 to 10 carbon atoms, a substituted or an unsubstituted alkynyl having 2 to 10 carbon atoms, and substituted or unsubstituted alkynyloxy having 2 to 10 carbon atoms, and H in R₃ and R₄ is unsubstituted or at least one H is substituted by any one of F, Cl, Br and I.

8. The liquid crystal composition according to claim 7, further comprises at least a third compound with a structure represented by at least one of formulas III-1 to III-5: 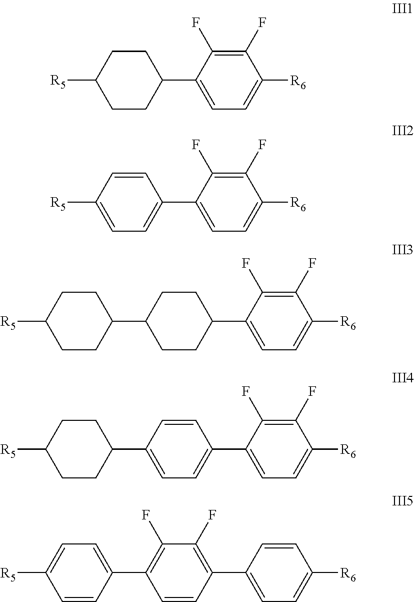
wherein R₅ and R₆ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or unsubstituted alkenyloxy having 2 to 10 carbon atoms, a substituted or unsubstituted alkynyl having 2 to 10 carbon atoms, and a substituted or unsubstituted alkynyloxy having 2 to 10 carbon atoms, and H in R₅ and R₆ is unsubstituted or at least one H is substituted with any one of F, Cl, Br, I, CH₃ and CN.

9. The liquid crystal composition according to claim 8, wherein in the liquid crystal composition, a mass fraction of the first compound is greater than or equal to 1%, and the mass fraction of the first compound is less than or equal to 70%;
in the liquid crystal composition, a mass fraction of the second compound is greater than or equal to 10%, and the mass fraction of the second compound is less than or equal to 70%; and
in the liquid crystal composition, a mass fraction of the third compound is greater than or equal to 10%, and the mass fraction of the third compound is less than or equal to 70%.

10. The liquid crystal composition according to claim 2, further comprises at least a second compound with a structure represented by at least one of formulas II-1 to II-9: 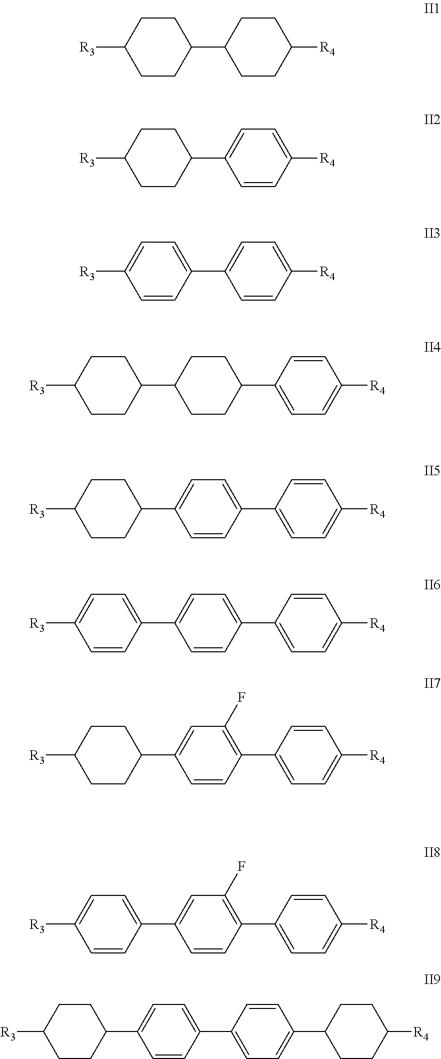
wherein R₃ and R₄ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or an unsubstituted alkenyloxy having 2 to 10 carbon atoms, a substituted or an unsubstituted alkynyl having 2 to 10 carbon atoms, and substituted or unsubstituted alkynyloxy having 2 to 10 carbon atoms, and H in R₃ and R₄ is unsubstituted or at least one H is substituted by any one of F, Cl, Br and I.

11. A display panel comprising a first substrate, a second substrate disposed on the first substrate, and a liquid crystal layer disposed between the first substrate and the second substrate;
wherein the liquid crystal layer comprises a liquid crystal composition, and the liquid crystal composition comprises at least a first compound represented by formula (I): 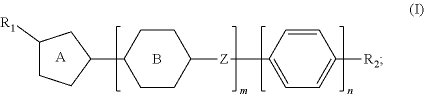
wherein, m and n are each independently selected from 0, 1, 2 and 3, and n and m are not both 0 at the same time; 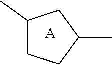
is independently selected from 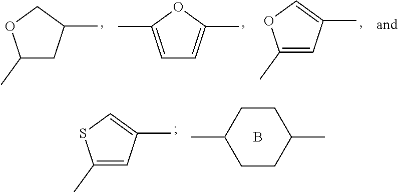
is independently selected from 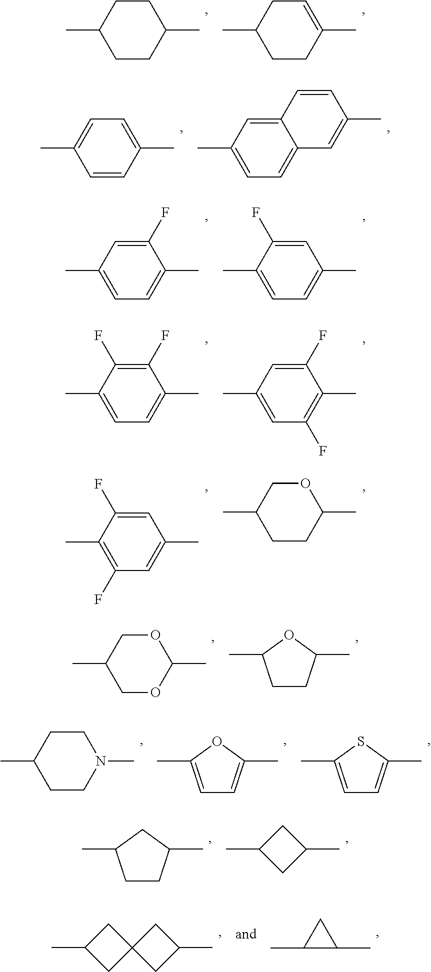
and at least one H in 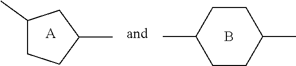
and is replaced with any one of F, CI, Br, I and H;
Z is independently selected from a single bond, —O—, —C(O)O—, —OC(O)—, —CF₂O—, —OCF₂—, —CH₂CH₂—, —CF₂CF₂—, —CH₂O—, —OCH₂—, —CH═CH— or —C≡C—, and in a case that any Z is selected from a group with H, the H in any Z is unsubstituted or at least one H is substituted with any one of F, Cl, Br and I; and
R₁ and R₂ are each independently selected from H, F, Cl, Br, I, CN, SCN, NCS, SFs, a substituted or an unsubstituted alkyl having 1 to 15 carbon atoms, a substituted or an unsubstituted alkoxy having 1 to 15 carbon atoms, a substituted or an unsubstituted alkenyl having 2 to 15 carbon atoms, a substituted or an unsubstituted alkenyloxy having 2 to 15 carbon atoms, a substituted or an unsubstituted alkynyl having 2 to 15 carbon atoms, and a substituted or an unsubstituted alkynyloxy having 2 to 15 carbon atoms.

12. The display panel according to claim 11, wherein terminal groups of R₁ and R₂ selected from the substituted or the unsubstituted alkyl having 1 to 15 carbon atoms, the substituted or the unsubstituted alkoxy having 1 to 15 carbon atoms, the substituted or the unsubstituted alkenyl having 2 to 15 carbon atoms, the substituted or the unsubstituted alkenyloxy having 2 to 15 carbon atoms, the substituted or the unsubstituted alkynl having 2 to 15 carbon atoms, and the substituted or the unsubstituted alkynyloxy having 2 to 15 carbon atoms are each independently monosubstituted with H, CN or CF₃; and/or,
one or more —CH₂— in R₁ and R₂ are each independently substituted with —O—, —S—, —SO₂—, —CO—, —C(O)O—, —OC(O)—, —OC(O)O—, —CF₂O—, —OCF₂—, —CH₂—CH₂—, —(CH₂)₃—, —CF₂—CF₂—, —CF₂—CH₂—, —CH₂—CF₂—, —CHF—CHF—, —CH₂O—, —OCH₂—, —CF═CH—, —CH═CF—, —CF═CF—, —CH═CH— or —C≡C—, and are not directly bonded to heteroatoms that are directly bonded to C, and H in R₁ and R₂ is unsubstituted or at least one H is substituted with any one of F, Cl, Br and I.

13. The display panel composition according to claim 11, wherein the first compound has a structure represented by at least one of formulas I-1 to I-37:

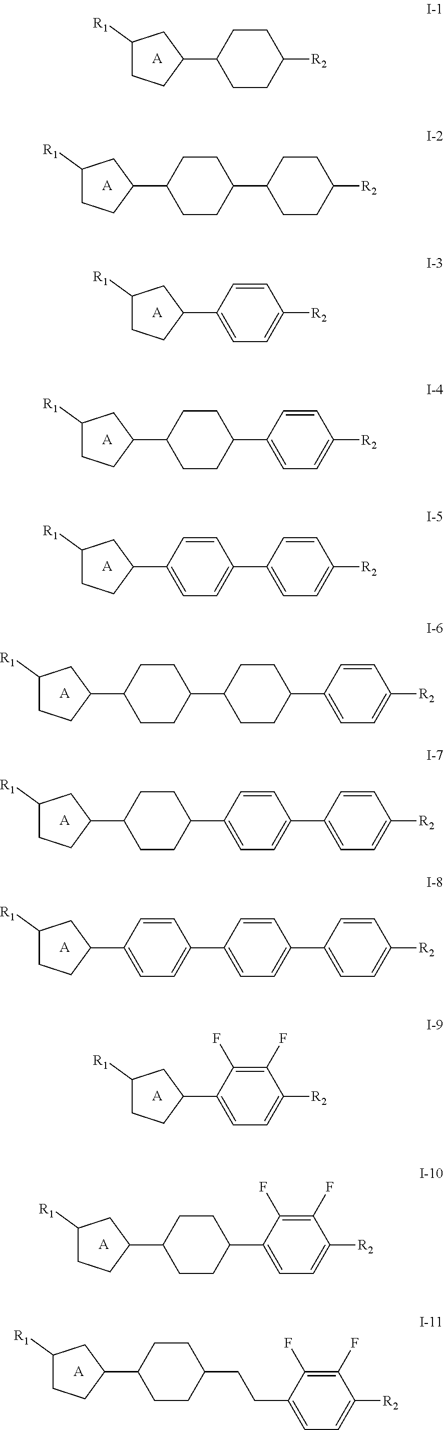

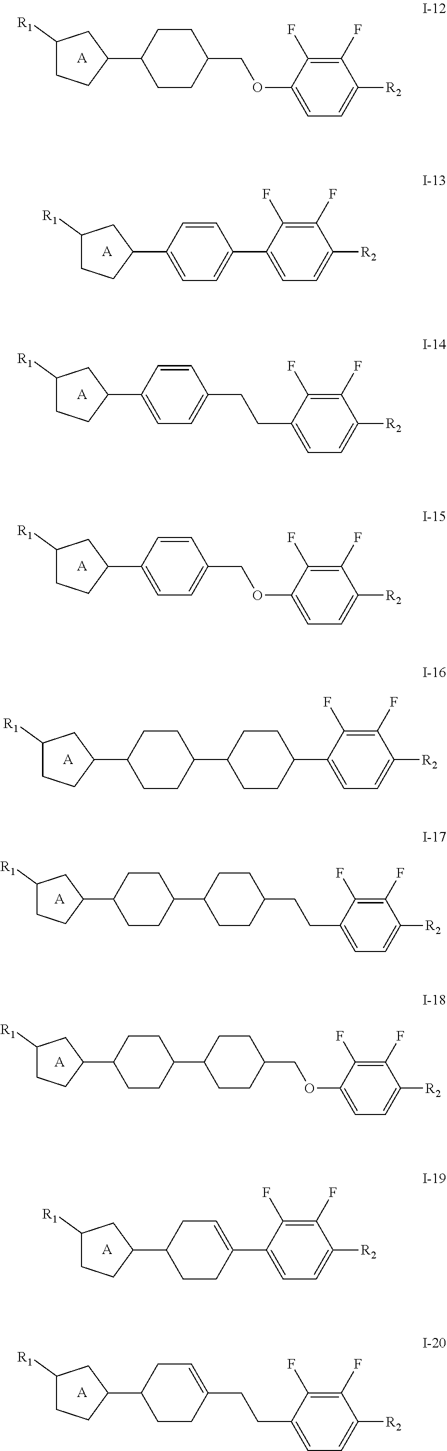

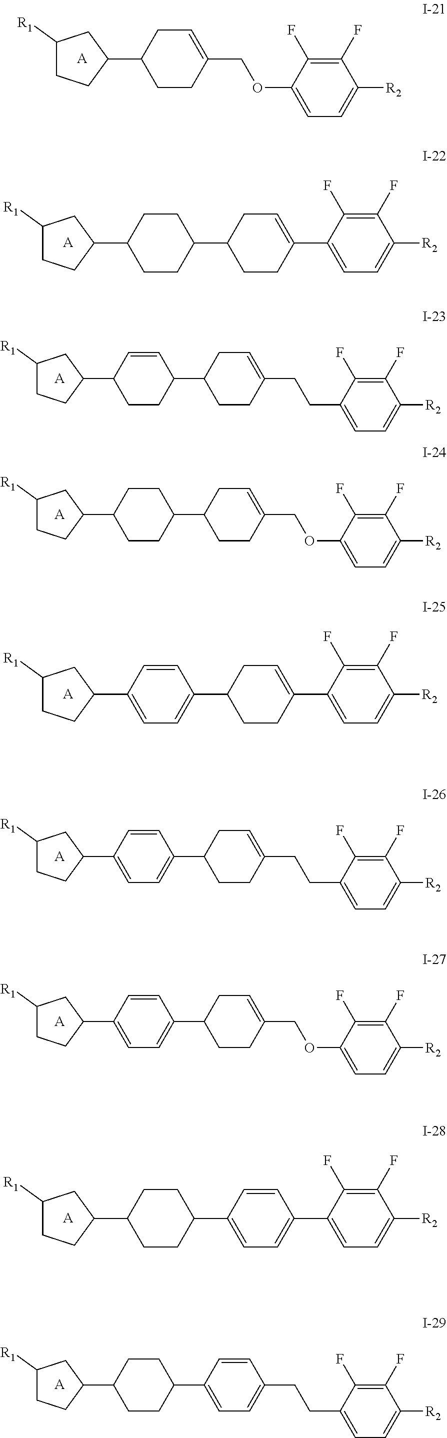

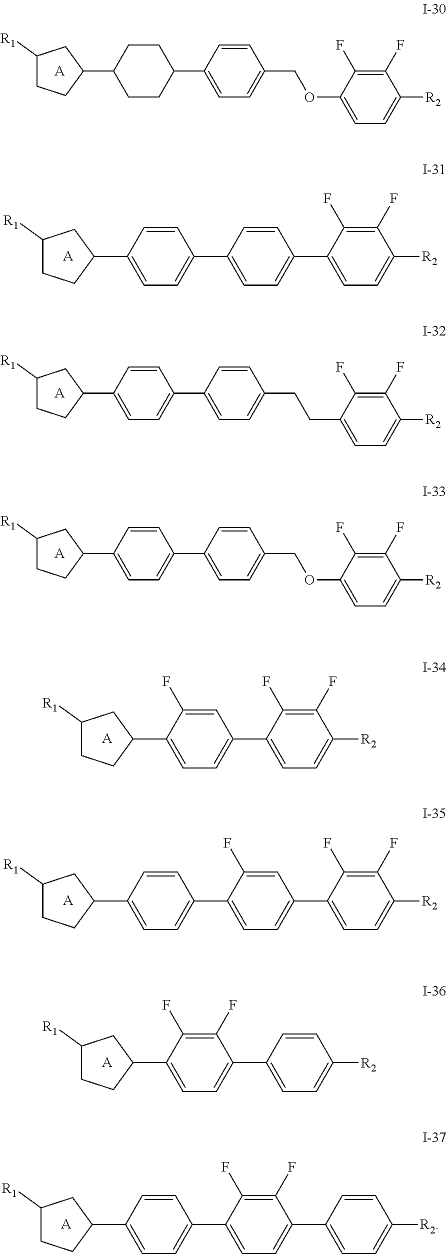

14. The display panel according to claim 13, wherein 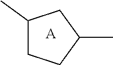
is independently selected from

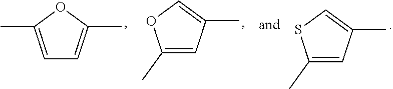

15. The display panel according to claim 13, wherein the first compound has a structure represented by at least one of the following formulas:

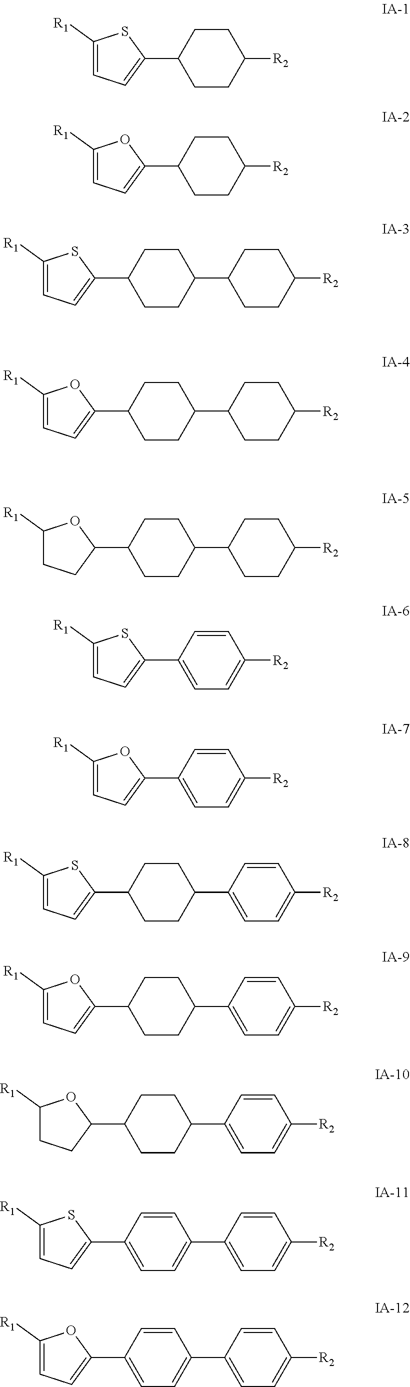

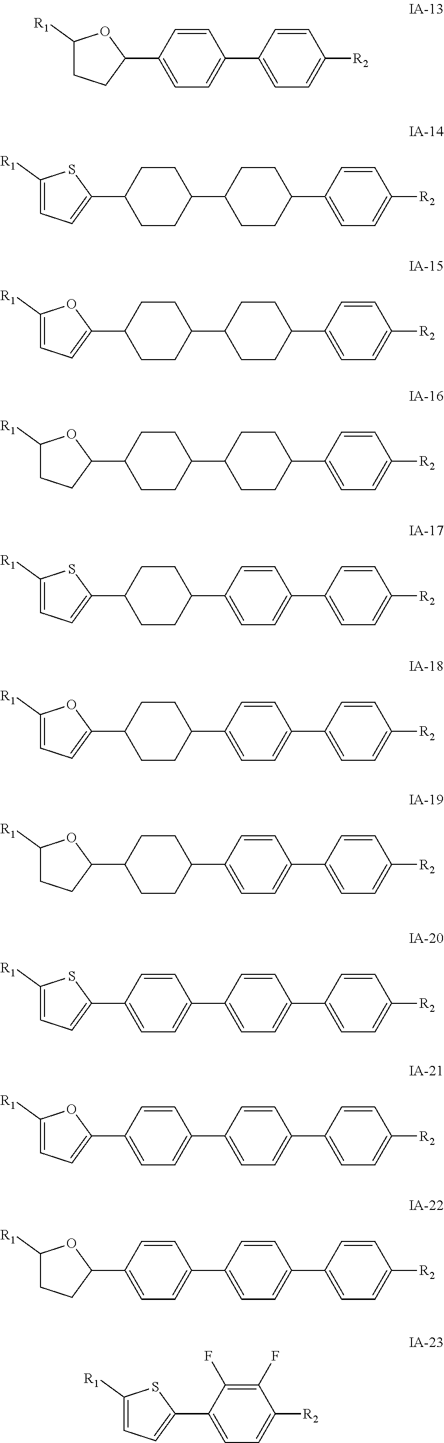

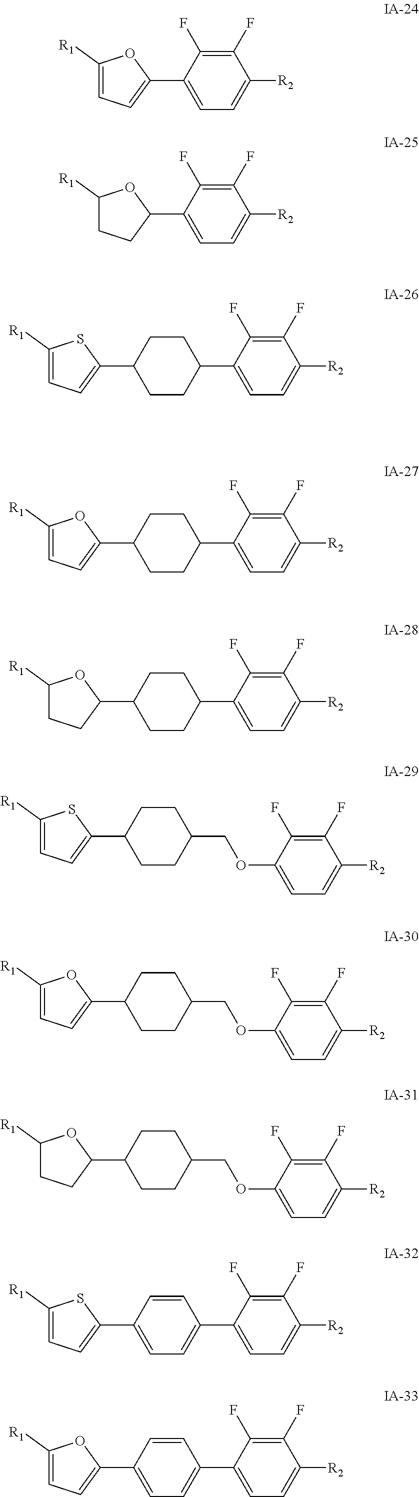

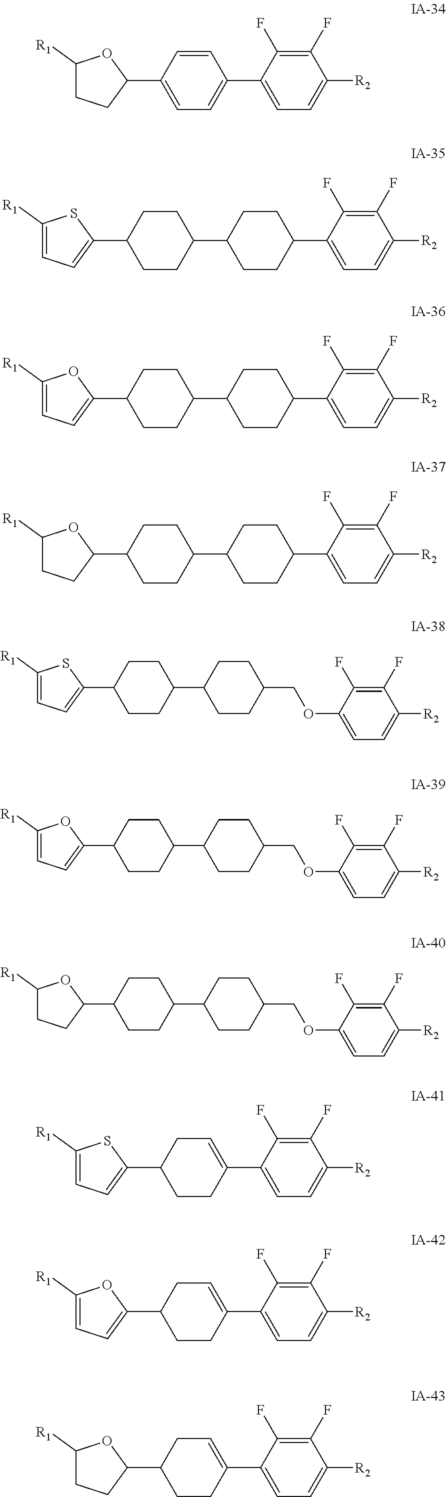

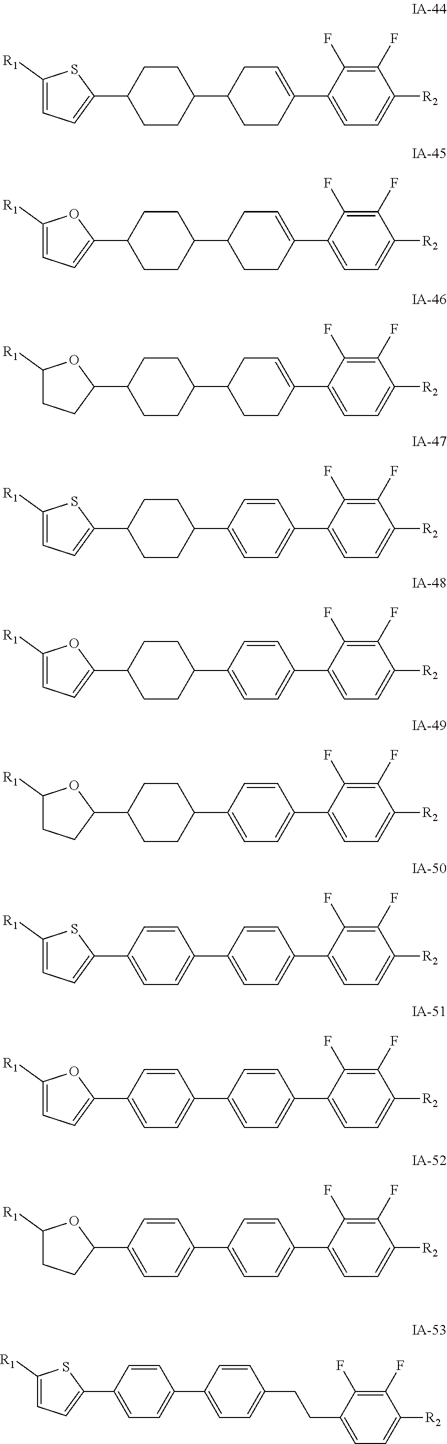

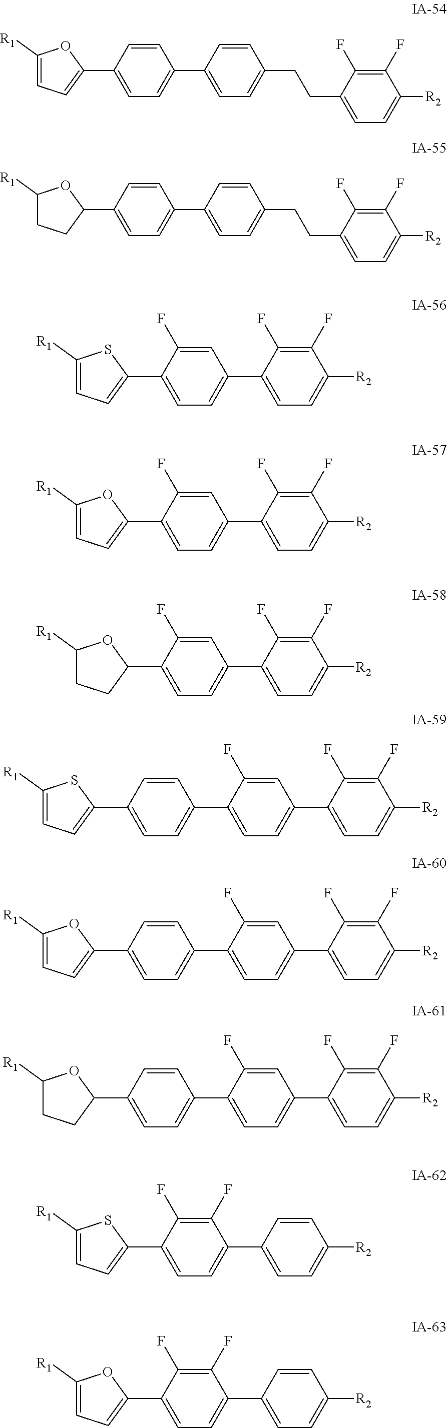

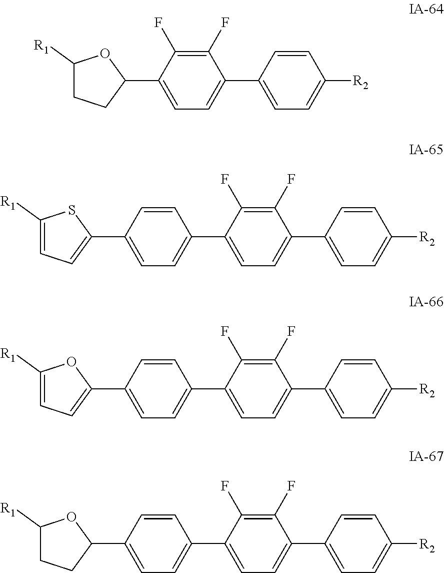

16. The display panel according to claim 15, wherein R₁ and R₂ are each independently selected from H, F, an unsubstituted alkyl having 1 to 7 carbon atoms, an unsubstituted alkoxy having 1 to 7 carbon atoms, and an unsubstituted alkenyl having 2 to 7 carbon atoms.

17. The liquid crystal composition according to claim 11, further comprises at least a second compound with a structure represented by at least one of formulas II-1 to II-9: 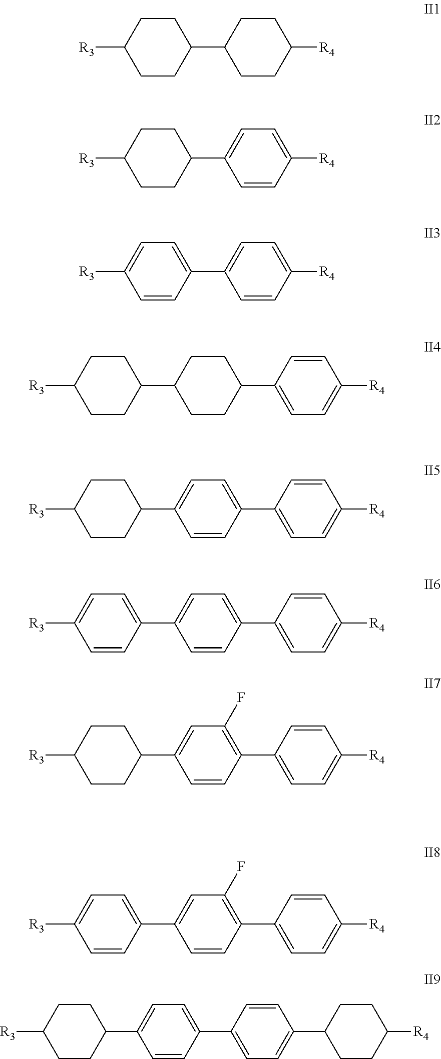
wherein R₃ and R₄ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or an unsubstituted alkenyloxy having 2 to 10 carbon atoms, a substituted or an unsubstituted alkynyl having 2 to 10 carbon atoms, and substituted or unsubstituted alkynyloxy having 2 to 10 carbon atoms, and H in R₃ and R₄ is unsubstituted or at least one H is substituted by any one of F, Cl, Br and I.

18. The display panel according to claim 17, further comprises at least a third compound with a structure represented by at least one of formulas III-1 to III-5: 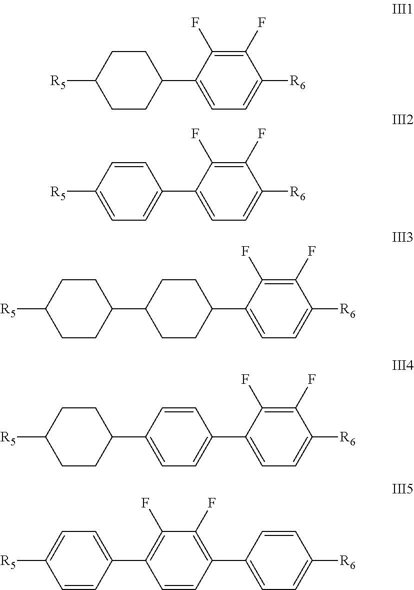
wherein R₅ and R₆ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or unsubstituted alkenyloxy having 2 to 10 carbon atoms, a substituted or unsubstituted alkynyl having 2 to 10 carbon atoms, and a substituted or unsubstituted alkynyloxy having 2 to 10 carbon atoms, and H in R₅ and R₆ is unsubstituted or at least one H is substituted with any one of F, Cl, Br, I, CH₃ and CN.

19. The display panel according to claim 18, wherein in the liquid crystal composition, a mass fraction of the first compound is greater than or equal to 1%, and the mass fraction of the first compound is less than or equal to 70%;
in the liquid crystal composition, a mass fraction of the second compound is greater than or equal to 10%, and the mass fraction of the second compound is less than or equal to 70%; and
in the liquid crystal composition, a mass fraction of the third compound is greater than or equal to 10%, and the mass fraction of the third compound is less than or equal to 70%.

20. The display panel according to claim 12, further comprises at least a second compound with a structure represented by at least one of formulas II-1 to II-9: 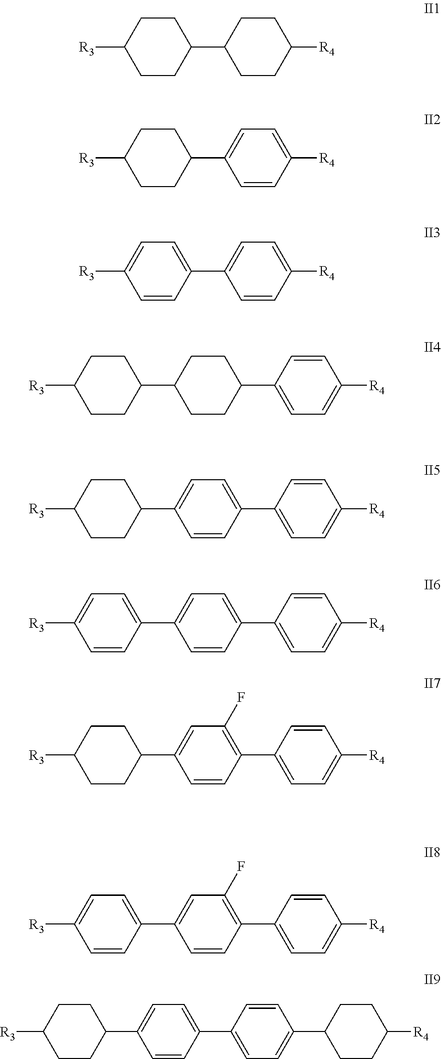
wherein R₃ and R₄ are each independently selected from a substituted or an unsubstituted alkyl having 1 to 10 carbon atoms, a substituted or an unsubstituted alkoxy having 1 to 10 carbon atoms, a substituted or an unsubstituted alkenyl having 2 to 10 carbon atoms, a substituted or an unsubstituted alkenyloxy having 2 to 10 carbon atoms, a substituted or an unsubstituted alkynyl having 2 to 10 carbon atoms, and substituted or unsubstituted alkynyloxy having 2 to 10 carbon atoms, and H in R₃ and R₄ is unsubstituted or at least one H is substituted by any one of F, Cl, Br and I.
